(19) United States
(12) Patent Application Publication
(10) Pub. No.: US 2016/0356897 A1
(43) Pub. Date: Dec. 8, 2016

(54) WAVEFORM DISCRIMINATION DEVICE, WAVEFORM DISCRIMINATION METHOD, AND WAVEFORM DISCRIMINATION PROGRAM

(71) Applicants: ANSeeN, INC., Hamamatsu-shi (JP); NATIONAL UNIVERSITY CORPORATION SHIZUOKA UNIVERSITY, Shizuoka-shi (JP)

(72) Inventors: Toru AOKI, Shizuoka (JP); Akifumi KOIKE, Shizuoka (JP)

(73) Assignees: ANSeeN, INC., Hamamatsu-shi (JP); National University Corporation Shizuoka University, Shizuoka-shi (JP)

(21) Appl. No.: 15/121,645

(22) PCT Filed: Feb. 28, 2014
(86) PCT No.: PCT/JP2014/001106

§ 371 Date: Aug. 25, 2016

(51) Int. Cl. G01T 1/208

(52) U.S. Cl. CPC G01T 1/208

(57) ABSTRACT

A waveform discrimination device includes: a waveform detector receiving waveforms of pulses to be measured and converting the waveforms to electrical signals; an analog amplifier expanding transient waveforms of the electrical signals along a time-domain axis; an AD converter converting the electrical signals to digital data in rise and fall times of the electrical signals; and a signal processing circuit calculating a characteristic-amount of the rise time as a point on a first coordinate axis by using the digital data, and calculating a characteristic-amount of the fall time as a point on a second coordinate axis, so as to define a set of the points on the first and second coordinate axes as a coordinate point, and plot the coordinate point on a discrimination plane, wherein, by plotted positions of the coordinate point, whether the pulses has a first waveform or a second waveform is discriminated.

### CROSS-REFERENCE TO RELATED APPLICATIONS

This application is a U.S. National Stage application, which claims the benefit under 35 U.S.C. §371 of PCT International Patent Application No. PCT/JP2014/001106, filed Feb. 28, 2014, the contents of which are incorporated herein by reference.

### TECHNICAL FIELD

The present invention relates to a waveform discrimination device discriminating double pulse waveforms having different waveforms, and more particularly, a waveform discrimination device, a waveform discrimination method, and a waveform discrimination program discriminating electrical signals caused by physical quantities of double pulse waveforms having different rise characteristic and fall characteristic, for example, like a case where gamma ray and neutron ray are incident on a scintillator.

### BACKGROUND ART

Like a case where gamma ray and neutron ray are incident on a scintillator and light having different waveforms are generated in the scintillator, there is a case where pulses with arbitrary strengths having first waveforms with similar shapes are generated at arbitrary timing to form a group, and another pulses with arbitrary strengths having second waveforms having similar shapes, which are different from the first waveforms, are generated at arbitrary timing to implement another group. Namely, let's consider a situation where light signals having a first waveform, which are caused by incidence of gamma ray, are generated with arbitrary strengths at arbitrary timing, implementing a group of the light signals as an output of a scintillator. Then, a photo detector, which has received the group of the light signals, sequentially transmits a first electrical signal corresponding to the first waveform. In such a situation, if another light signals having a second waveform caused by incidence of neutron ray are generated with arbitrary strengths at arbitrary timing to implement another group of the light signals so that the photo detector received the another group of the light signals sequentially transmits a second electrical signal corresponding to the second waveform, there is a case that discrimination of the first waveform and the second waveform different from the first waveform is desired.

In a case where a gamma ray and a neutron ray are simultaneously incident on a single scintillator made from a crystal of LiCaAlF₆ doped with Ce, it is known that light emission of the waveform unique to the gamma ray and another light emission of the waveform unique to the neutron ray are generated from the scintillator. For this reason, proposed was a system where the two types of light emission from the scintillator are converted to electrical signals by a photomultiplier tube, and an output of the photomultiplier tube is amplified by a charge-sensitive preamplifier and a waveform shaping amplifier (shaping amp) to be analyzed by a double-input multichannel analyzer (MCA) (refer to “Non-Patent Literature (PTL)” 1).

In the invention disclosed in Non-PTL 1, an output of the waveform shaping amplifier is divided into a peak value observation output and a rise time observation output, the peak value observation output is directly fed to one input terminal of the double-input MCA, and the rise time observation output is transferred to a pulse waveform analyzing instrument. In addition, the pulse waveform analyzing instrument transmits two signals at timing of 10% and 90% of a rise time, the two signals are fed to a time/amplitude converter, the time/amplitude converter converts a time difference between the two signals to an amplitude of the pulse, and an output of the time/amplitude converter is transferred to the other input terminal of the double-input MCA. Like this, a very complicated, large-sized, and expansive system organization was used.

In the invention disclosed in Non-PTL 1, as illustrated in FIG. 3 of Non-PTL 1, by plotting the rise time and the peak value (Pulse Height) of the gamma and neutron rays on a coordinate plane, the gamma ray and the neutron ray are separated to be displayed. However, in the invention disclosed in Non-PTL 1, as illustrated in FIG. 3 of Non-PTL 1, by neutron and gamma ray simultaneously radiating from californium 252 (²⁵²Cf) as a generation source of radiation, the waveforms of the two rays overlap with each other on the peak value axis as well as the time-domain axis.

This is because, due to delay caused by transient characteristic (slew rate) of the charge-sensitive preamplifier illustrated in FIG. 1 of Non-PTL 1, the rise time of a high-speed signal having a large input-signal peak-value is also increased. Therefore, in the invention disclosed in Non-PTL 1, in a case where energy of incident gamma ray is equal to or higher than energy of neutrons, the discrimination is not possible, so that counting error occurs.

In addition, in a measurement system used in the invention disclosed in Non-PTL 1, in a two-dimensional distribution diagram disclosed in FIG. 5 of Non-PTL 1, within a rectangular range of a count-region-of-interest (count-ROI) A for neutrons originally desired to be extracted, another rectangular count-ROI B is set, for suppressing the extraction of gamma ray as a non-measurement object. In the invention disclosed in Non-PTL 1, on the coordinate plane which is within the region of the count-ROI A, setting of the region of the count-ROI B is manually adjusted while viewing a plot of data on the two-dimensional distribution diagram, so that attention and skill of persons are needed in order to reduce the error. However, as illustrated in FIG. 5 of Non-PTL 1, a plot trajectory of gamma ray is non-linear, so that it is difficult to accurately separate the plot from a plot of neutrons.

Namely, even though a large-sized, expansive, and complicated system organization using a desktop-sized MCA is used like the invention disclosed in Non-PTL 1, in the related art, input waveforms of the gamma and neutron rays incident as independent events at random cannot be discriminated so that the ray amount of each ray cannot be counted in real time. In addition, the ray amounts of the gamma and neutron rays cannot be accurately measured in real time.

In addition, in Non-PTL 1, since treatment for a case where the input signals caused by the gamma and neutron rays are incident within a short time interval is not considered, and in a case where the input signals caused by the gamma and neutron rays exist within a time interval shorter than a time constant of the pulse waveform analyzing instrument, pile-up occurs, so that accurate energy cannot be measured, and thus, accuracy is lowered.

### CITATION LIST

### Non-Patent Literature

Non-PTL 1: Yamazaki Atsushi and other 11 persons, “Neutron-gamma discrimination based on pulse shape discrimination in a Ce:LiCaAlF₆ scintillator” Nuclear Instruments and Methods in Physics Research A, Vol. 652, p. 435-438., 2011

### SUMMARY OF THE INVENTION

### Technical Problem

The invention is to provide a waveform discrimination device which can be integrated on a small-sized circuit board, so that the waveform discrimination device can be easily embodied by portable structures by a simple, inexpensive configuration, a waveform discrimination method, and a waveform discrimination program.

### Solution to Problem

In order to achieve the object, the inventors focused on a current waveform according to light emission at the time when gamma rays as a pulse of a physical quantity having an arbitrary strength having a first waveform are incident on a scintillator and a current waveform according to light emission at the time when neutrons as a pulse of a physical quantity having an arbitrary strength having a second waveform are incident on the scintillator.

Namely, as an exemplary review, if the current waveforms according to light emission at the time when the gamma rays and the neutrons are simultaneously incident on the scintillator or one of the gamma rays and the neutrons is incident on the scintillator are compared, with respect to the gamma ray, a signal intensity of a rising portion and an attenuation intensity of a falling portion are linearly proportional to each other, and with respect to the neutron, there is a non-linear relationship. By applying this physical phenomenon, the inventors contrived a waveform discrimination device, a waveform discrimination method, and a waveform discrimination program of accurately separating and counting the physical quantities having arbitrary strengths having the first and second waveforms.

According to a first aspect of the invention, there is provided a waveform discrimination device including: (a) a waveform detector configured to convert physical quantities of pulses to be measured to electrical signals, by receiving waveforms of the pulses; (b) an analog amplifier configured to amplify transient waveforms of the electrical signals by expanding the transient waveforms of the electrical signals along a time-domain axis; (c) an AD converter configured to sample the amplified electrical signals in rise and fall times of the electrical signals and convert the sampled electrical signals to digital data; and (d) a signal processing circuit configured to calculate a characteristic-amount of the rise time as a point on a first coordinate axis by using the digital data, and calculate a characteristic-amount of the fall time as a point on a second coordinate axis, so as to define a set of the point on the first coordinate axis and the point on the second coordinate axis as a coordinate point, and plot the coordinate point on a discrimination plane defined by the first coordinate axis and the second coordinate axis. The waveform discrimination device according to the first aspect discriminates whether the pulses has a first waveform or a second waveform different from the first waveform is discriminated, by plotted positions of the coordinate point.

According to a second aspect of the invention, there is provided a waveform discrimination method including steps of: (a) receiving waveforms of pulses to be measured and converting a physical quantity of the pulses to electrical signals; (b) amplifying transient waveforms of the electrical signals by expanding the transient waveforms of the electrical signals along a time-domain axis; (c) sampling the amplified electrical signals in rise and fall times of the electrical signals and converting the sampled electrical signals to digital data; (d) calculating a characteristic-amount of the rise time as a point on the first coordinate axis by using the digital data, and calculating a characteristic-amount of the fall time as a point on the second coordinate axis; (e) defining a set of the point on the first coordinate axis and the point on the second coordinate axis as a coordinate point and plotting the coordinate point on a discrimination plane defined by the first coordinate axis and the second coordinate axis; and (0 discriminating from a plotted position of the coordinate point whether the pulses has a first waveform or a second waveform different from the first waveform.

A computer software program for implementing the waveform discrimination method disclosed in the second aspect of the invention is stored in a computer-readable recording medium, and by allowing a computer system to read the recording medium, the waveform discrimination method according to the invention can be executed.

According to a third aspect of the invention, there is provided a waveform discrimination program allowing a control circuit to execute a series of instructions including: (a) instructions to a waveform detector to convert a physical quantity of pulses to be measured to electrical signals, by receiving a waveform of the pulses; (b) instructions to an analog amplifier to amplify transient waveforms of the electrical signals by expanding the transient waveforms of the electrical signals along a time-domain axis; (c) instructions to an AD converter to sample the amplified electrical signals in rise and fall times of the electrical signals and to convert the sampled electrical signals to digital data; (d) instructions to a difference value calculation circuit, an attenuation amount calculation circuit, and a difference value integration circuit of a signal processing circuit to cooperate with each other to calculate a characteristic-amount of the rise time as a point on the first coordinate axis by using the digital data and calculate a characteristic-amount of the fall time as a point on the second coordinate axis; (e) instructions to a two-dimensional coordinate plotting circuit of the signal processing circuit to define a set of the point on the first coordinate axis and the point on the second coordinate axis as a coordinate point and to plot the coordinate point on a discrimination plane defined by the first coordinate axis and the second coordinate axis; and (f) instructions to a waveform discrimination determination circuit of the signal processing circuit to discriminate from a plotted position of the coordinate point whether the pulse has a first waveform or a second waveform different from the first waveform.

Herein, the “recording medium” denotes a medium where a program can be recorded, for example, an external memory device of a computer, a semiconductor memory, a magnetic disk, an optical disk, a magneto-optical disk, a magnetic tape, or the like. More specifically, a flexible disk, a CD-ROM, an MO disk, a cassette tape, an open reel tape, and the like are included in the “recording medium”. The waveform discrimination device according to the first aspect can be miniaturized in device size, and at the time of designing the miniaturization, the waveform discrimination device can be implemented by an embedded processor in various equipment such as a microcontroller unit (MCU). A configuration of a recording medium or the like storing the waveform discrimination program according to the third aspect can be implemented. With respect to the MCU, at first time, due to shortage of an installed memory, a program was produced in only an assembly language. As the amount of a memory or the processing capacity of a CPU is increased, the C language has been used in terms of development efficiency. There has been a half-finished product where a language processing system such as a BASIC language interpreter is written in a ROM in advance, and thus, a recording medium or the like storing the waveform discrimination program according to the third aspect can be implemented.

### Effect of the Invention

According to the invention, it is possible to provide a waveform discrimination device which can be integrated on a small-sized circuit board, so that the waveform discrimination device can be easily embodied by portable structures by a simple, inexpensive configuration, a waveform discrimination method, and a waveform discrimination program.

### BRIEF DESCRIPTION OF DRAWINGS

FIG. 1 is a schematic block diagram illustrating an overview of main components of a waveform discrimination device according to a first embodiment of the present invention;

FIG. 2 is a detailed diagram illustrating an example of an analog amplifier used for the waveform discrimination device according to the first embodiment;

FIG. 3 is a schematic perspective diagram illustrating an overview of main components in a physical implementation structure of the waveform discrimination device according to the first embodiment with sidewalls of a housing being illustrated to be transparent.

FIG. 4A is a diagram illustrating a pulse waveform obtained by observing a first electrical signal as an output of a photomultiplier tube by using an oscilloscope in a case where the output of the photomultiplier tube as a photo detector is terminated with 50Ω, and when gamma ray is incident on a scintillator, light having a first waveform emitted from the scintillator is incident on the photomultiplier tube. FIG. 4B is a diagram illustrating a pulse waveform obtained by observing the first electrical signal illustrated in FIG. 4A by using an oscilloscope in a case where the output of the photomultiplier tube is terminated with 50 kΩ;

FIG. 5 is a diagram illustrating a pulse waveform indicated in a portion V of the first electrical signal of FIG. 4A by expanding the time-domain axis, and a pulse waveform of the second electrical signal together with the first electrical signal is also illustrated by using the common time-domain axis for comparison;

FIG. 6A is a diagram illustrating the portion V of FIG. 4A by expanding the time-domain axis similarly to FIG. 5, and FIG. 6B is a diagram illustrating the pulse waveform of the second electrical signal by using the common time-domain axis together with FIG. 6A for comparison;

FIG. 7A illustrates an output waveform of an analog amplifier of the waveform discrimination device according to the first embodiment, and FIG. 7B is a schematic diagram for supporting understanding of concept of a state where the AD converter converts the waveform of FIG. 7A to a digitization capable signal;

FIG. 8 is a schematic diagram illustrating contents of arithmetic operations and definitions as presumption in the case of calculating a characteristic-amount of the rise time and a characteristic-amount of the fall time by executing processes of FIG. 9 and FIG. 10 on digital data transferred from an AD converter;

FIG. 9 is a conceptual flowchart illustrating an example of a method of producing a two-dimensional distribution which becomes a basis of the waveform discrimination method according to the first embodiment of the present invention;

FIG. 10 is a conceptual flowchart illustrating the method of producing the two-dimensional distribution according to the first embodiment subsequent to FIG. 9;

FIG. 11 is a diagram illustrating that, by defining a characteristic-amount of a rise time as a point on a first coordinate axis, defining a characteristic-amount of a fall time as a point on a second coordinate axis, and plotting the points on a discrimination plane defined by the first coordinate axis and the second coordinate axis, distribution areas of gamma rays (first waveform) and neutron rays (second waveform) are localized, so that classification and arrangement can be performed;

FIG. 12 is a diagram illustrating a discrimination window and a straight line representing a discrimination linear equation used for the waveform discrimination method according to the first embodiment;

FIG. 13 is a conceptual diagram illustrating an internal structure of a signal processing circuit implementing the waveform discrimination device according to the first embodiment as a combination of logical hardware resources;

FIG. 14 is a diagram illustrating that, according to the waveform discrimination method according to the first embodiment, even in a case where there occurs pile-up where a falling waveform of an electrical signal as an output from a photo detector is overlapped with a rising waveform of a subsequent pulse signal, a correct peak value can be acquired as a schematic conceptual diagram illustrating a process state in an AD converter;

FIG. 15 is a conceptual flowchart illustrating a flow of processes using the discrimination window and the straight line representing the discrimination linear equation in the waveform discrimination method according to the first embodiment; and

FIG. 16 is a conceptual flowchart illustrating a method of determining the discrimination window and the straight line representing the discrimination linear equation used for the waveform discrimination method according to the first embodiment.

### DESCRIPTION OF EMBODIMENTS

Next, with reference to the drawings, a first embodiment of the present invention will be described. In the drawings described hereinafter, the same or similar components are denoted by the same or similar reference numerals. However, it should be noted that the drawings are schematic ones and specific thicknesses or sizes are determined in consideration of the hereinafter description. In addition, among the drawings, there are also included portions being different from each other in size relation and ratio.

In addition, the first embodiment described hereinafter is an embodiment exemplifying a device or method for embodying the technical spirit of the invention, and the technical spirit does not specify materials, shapes, structures, arrangement, and the like of component parts to the following ones. The technical spirit of the invention is within the technical scope defined by claims disclosed in the claims, and various changes may be added thereto.

(Configuration of Waveform Discrimination Device)

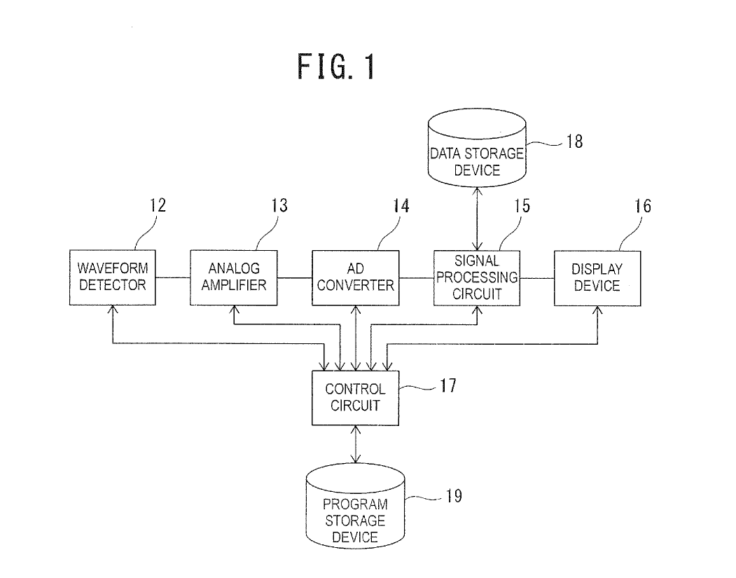

As illustrated in FIG. 1, a waveform discrimination device according to the first embodiment of the present invention includes a waveform detector 12 which receives a waveform of pulses-to-be-measured and converts a physical quantity of the measured pulse to an electrical signal, an analog amplifier 13 which is connected to the waveform detector 12 and amplifies a transient waveform of the electrical signal by expanding the transient waveform along a time-domain axis, an AD converter 14 which is connected to the analog amplifier 13 and samples the amplified electrical signal in rise and fall times of the electrical signal to convert the sampled electrical signal to digital data, a signal processing circuit 15 which is connected to the AD converter 14, calculates a characteristic-amount of the rise time as a point on a first coordinate axis by using the digital data, calculates a characteristic-amount of the fall time as a point on a second coordinate axis by using the digital data, defines a set of the point on the first coordinate axis and the point on the second coordinate axis as a coordinate point, and plots the coordinate point on a discrimination plane defined by the first coordinate axis and the second coordinate axis, a display device 16 and a data storage device 18 which are connected to the signal processing circuit 15, a control circuit 17 which is connected to the waveform detector 12, the analog amplifier 13, the AD converter 14, the signal processing circuit 15 and the display device 16, and a program storage device 19 which is connected to the control circuit 17.

In addition, in FIG. 1, for the convenience, each of the data storage device 18 and the program storage device 19 is illustrated as a single hardware resource. However, it does not exclude an organization where, as actual physical hardware resources, each of the data storage device 18 and the program storage device 19 is implemented by a set of a plurality of storage devices having different functions and sizes. For example, the data storage device 18 can also be implemented by an arbitrary combination appropriately selected from a group including a plurality of registers, a plurality of cache memories, a main storage device, and an auxiliary storage device. In addition, the cache memory may be established by a combination of a primary cache memory and a secondary cache memory, and furthermore, may implement a cache-hierarchy, which includes a tertiary cache memory.

The waveform detector 12 illustrated in FIG. 1 receives at least one pulse included in a first pulse group where pulses with arbitrary strengths having a first waveform of pulses-to-be-measured are generated at arbitrary timing to form a group and sequentially transmits a first electrical signal corresponding to the first waveform. In addition, the waveform detector receives at least one pulse included in a second pulse group where pulses with arbitrary strengths having a second waveform different from the first waveform as another measured pulse are generated at arbitrary timing to form another group and sequentially transmits a second electrical signal corresponding to the second waveform.

The analog amplifier 13 receives at least one of the first and second electrical signals as a discrimination object signal from the waveform detector 12 and amplifies a waveform of the discrimination object signal so as to expand a transient waveform of the discrimination object signal along the time-domain axis. It is preferable that, even with respect to a pulse of which the first waveform has a half width of a nano-second level as pulses-to-be-measured, the analog amplifier 13 expands, along the time-domain axis, the waveform representing a transient characteristic so that a fall time becomes a length of about two microseconds or more. If the fall time is at a microsecond level, a sampling interval of the AD converter 14 for acquiring digital data can be set to be long, so that a very inexpensive, simple AD converter 14 can be employed. In addition, the AD converter 14 samples the amplified discrimination object signal in rise and fall times of the discrimination object signal, generates discrete sets of data, each are separated by a constant interval, and converts the discrete sets of data to digital data.

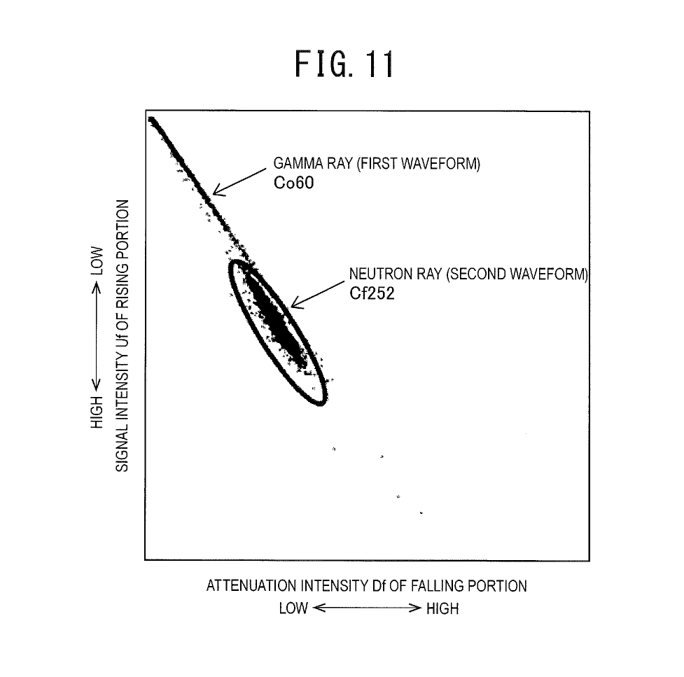

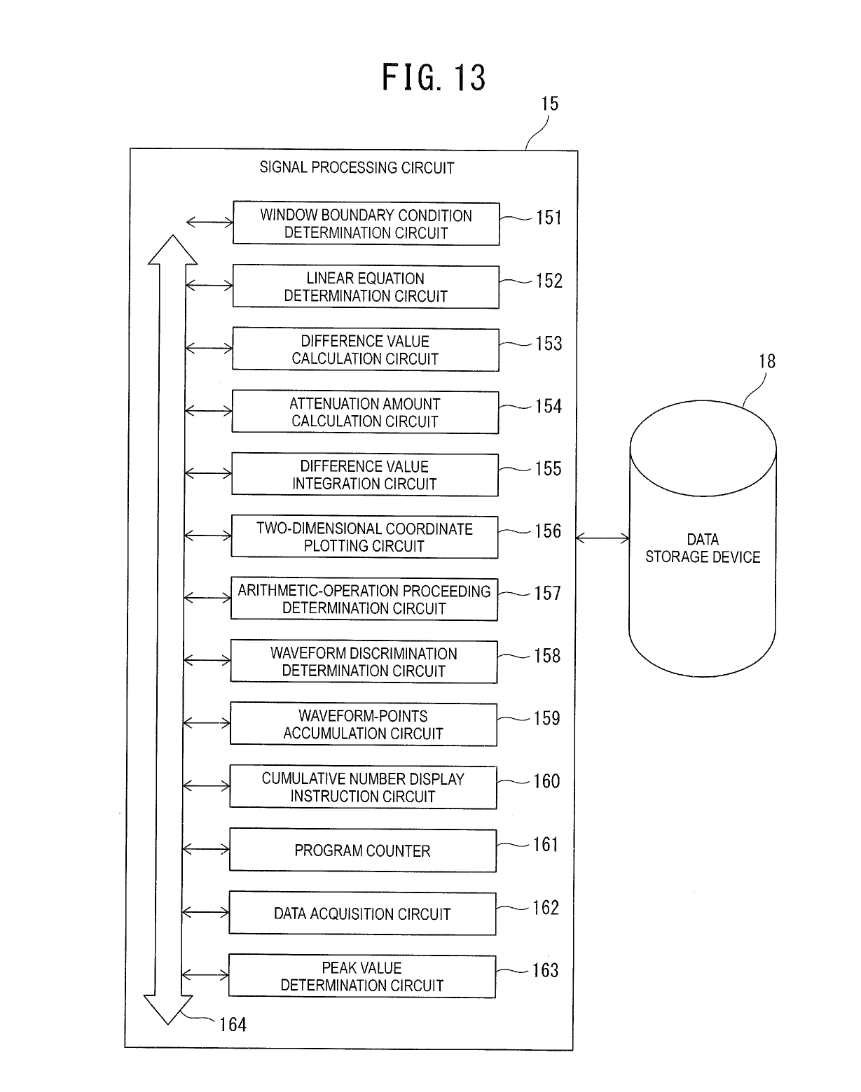

A data acquisition circuit 162 (refer to FIG. 13) of the signal processing circuit 15 sequentially reads the discrete digital data sampled and generated by the AD converter 14 from the AD converter 14 and temporarily store the discrete digital data in the data storage device 18. The signal processing circuit 15 reads the digital data stored in the data storage device 18, calculates a characteristic-amount Df of the fall time as a point on the second coordinate axis, and calculates a characteristic-amount Uf of the rise time as a point on the second coordinate axis perpendicular to the first coordinate axis. Next, a set (Uf, Df) of the point on the first coordinate axis and the point on the second coordinate axis is defined as a coordinate point, and as illustrated in FIG. 11, the signal processing circuit 15 automatically plots the coordinate points (Uf, Df) in real time on a discrimination plane defined by the first coordinate axis and the second coordinate axis while the process of sampling of the transient waveform by the AD converter 14 proceeds. Since the coordinate points (Uf, Df) are plotted in real time on the discrimination plane illustrated in FIG. 11, the data storage device 18 functions as a register of temporarily storing the digital data transferred from the AD converter 14.

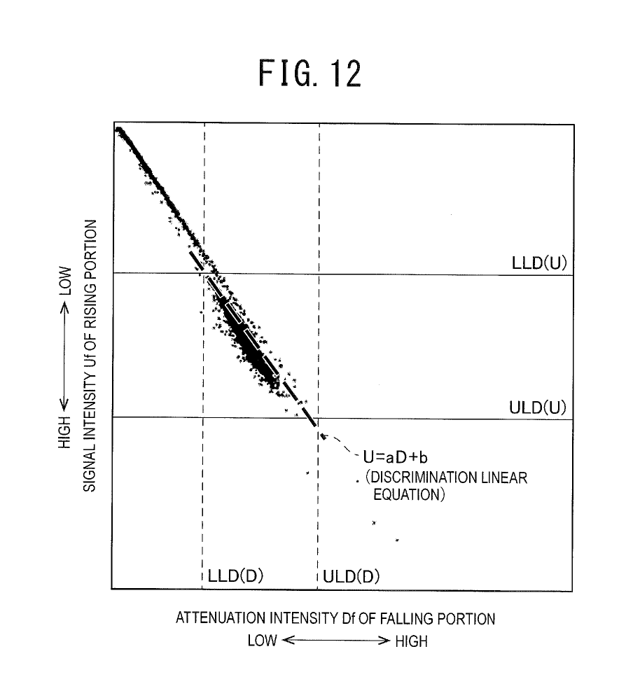

In FIG. 11 and FIG. 12 following FIG. 11, the second coordinate axis is illustrated to be in the X axis direction, and the value of the characteristic-amount Df of the fall time is plotted so that the value is increased as it goes rightward in the X-axis direction. On the other hand, in FIGS. 11 and 12, the first coordinate axis is illustrated to be in the Y axis direction, and the value of the characteristic-amount Uf of the rise time is plotted so that the value is decreased as it goes upward in the Y-axis direction and is increased as it goes downward in the Y-axis direction. Therefore, the discrimination plane defined by the first coordinate axis and the second coordinate axis is defined as a third-quadrant Cartesian coordinate. In addition, in FIGS. 11 and 12, the first coordinate axis is illustrated as the Y axis, and the second coordinate axis is illustrated as the X axis. However, this is merely an example. Any one of the X and Y axes may be set as the first coordinate axis, and the remaining one may be set as the second coordinate axis.

An organization of logical hardware resources of the signal processing circuit 15 is illustrated in FIG. 13. As the signal processing circuit 15, a microprocessor (MPU) or the like implemented by a microchip may be used. In addition, as the signal processing circuit 15, a digital signal processor (DSP) with an enhanced arithmetic operation function to be dedicated to a signal process, or alternatively, a micro-controller (micro-computer) assembled with various memories or peripheral circuits to be used for control units, or the like may be used. Furthermore, a main CPU of a current general-purpose computer may be used as the signal processing circuit 15.

The waveform discrimination device according to the first embodiment can automatically discriminate in real time from a distribution position of the coordinate point on the discrimination plane illustrated in FIG. 11 whether the discrimination object signal is pertains to the first waveform as a generation source or pertains to the second waveform as a generation source. Particularly, with respect to the discrimination plane illustrated in FIG. 11, by defining a discrimination window and a discrimination linear equation as illustrated in FIG. 12, it can be automatically discriminated in real time by a process of computer software whether the discrimination object signal is pertains to the first waveform as a generation source or pertains to the second waveform as a generation source.

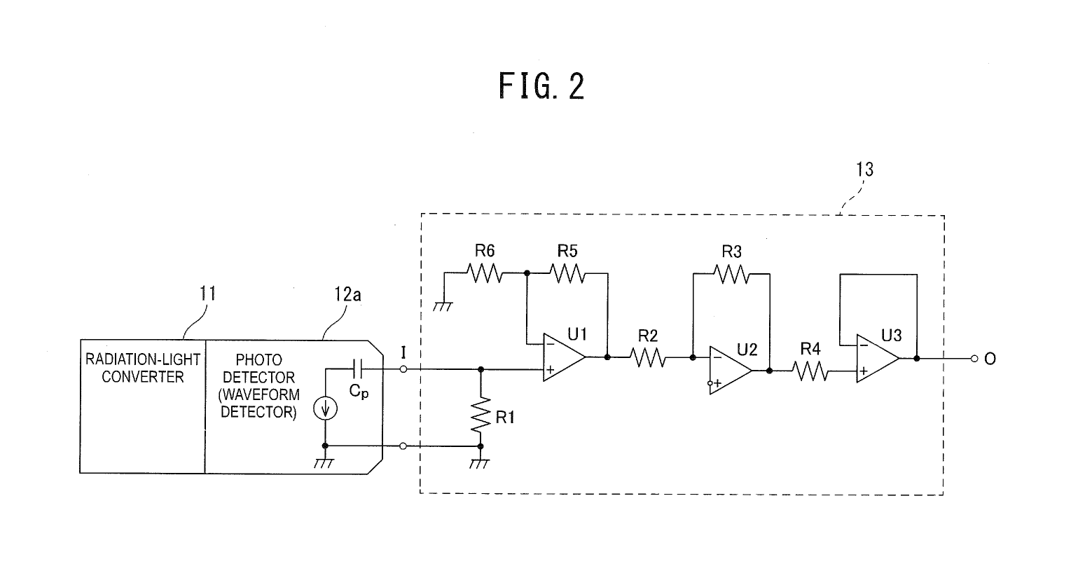

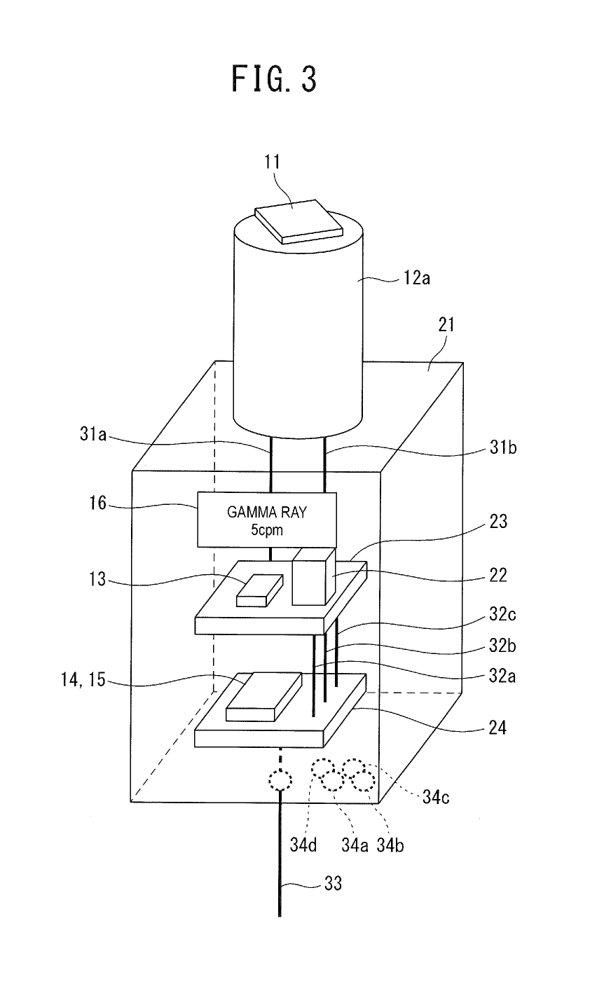

A configuration illustrated in FIG. 2 and FIG. 3 relates to a specific application example of a waveform discrimination device according to the first embodiment, representing a case that the first waveform of the pulse-to-be-measured corresponds to an emitted-light waveform unique to gamma ray from a radiation-light converter 11, and that the second waveform of the pulse-to-be-measured corresponds to an emitted-light waveform unique to neutron ray from the radiation-light converter 11. Namely, in the hereinafter description, the first waveform is exemplarily described as an emitted-light waveform due to the gamma ray entered to the radiation-light converter 11, and the second waveform is exemplarily described as an emitted-light waveform due to the neutron ray entered to the radiation-light converter 11.

In other words, as illustrated in FIGS. 2 and 3, the waveform discrimination device according to the first embodiment includes a radiation-light converter 11 converting the neutron ray and the gamma ray to light, and a photo detector 12a being connected to the radiation-light converter 11 and converting the emitted light from the radiation-light converter 11 to an electrical signal. As the radiation-light converter 11 converting the neutron ray and the gamma ray to lights, which have different physical quantities representing different waveforms of the respective transient characteristics, CsLiYCl, LiCaAlF₆, LiF/ZnS, LiBaF₃, Li₆Gd(BO₃)₃, or the like as listed in Table 1 can be used.

TABLE 1

| Name | Wavelength of Emitted light |
|---|---|
| CsLiYCl | Ce 380 nm |
| LiCaAlF₆ | Eu—Na 370 nm, Ce 280-320 nm |
| LiF/ZnS | Ag 450 nm |
| LiBaF₃ | Ce—K 190-330 nm |
| Li₆Gd(BO₃)₃ | Ce 385, 415 nm |

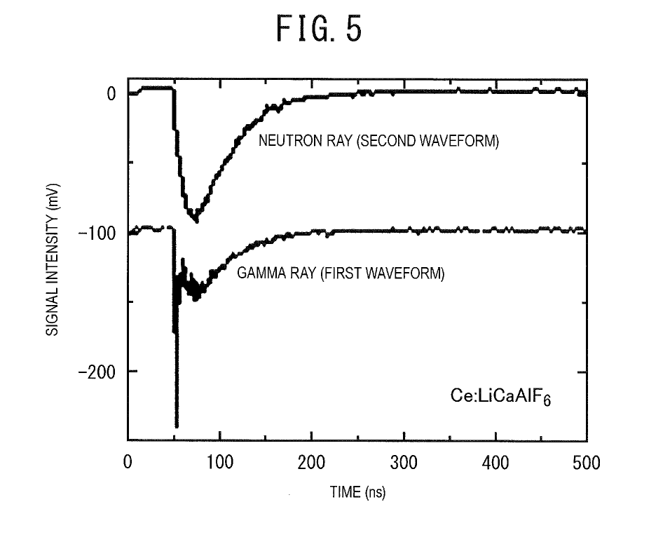

As listed in Table 1, in order to obtain stronger light emission, it is preferable that elements as emission centers, for example, Y, Ce, Pr, Sm, Eu, Tb, Mn, or the like are doped to a scintillator material such as CsLiYCl, LiCaAlF₆, LiF/ZnS, LiBaF₃, or Li₆Gd(BO₃)₃. For example, in a case where LiCaAlF₆ doped with Ce is used as the radiation-light converter 11, as illustrated in FIG. 5, with respect to the transient characteristics of the light emission from the radiation-light converter 11, each of the rise characteristic and the fall characteristic is different between the gamma ray (first waveform) and the neutron ray (second waveform).

In FIG. 5, the emitted light ascribable to the gamma ray (first waveform) includes light emission having a very short light emission time of about several nano-seconds and broad light emission which is subsequent to a leading sharp peak. On the other hand, as illustrated in FIG. 5, the light emission ascribable to the neutron ray (second waveform) is characterized by light emission having a relatively long light emission time of about several hundreds of nano-seconds or less. The light emission ascribable to the gamma ray (first waveform) is referred to as Cherenkov light emission.

As listed in Table 1, since the scintillator such as CsLiYCl, LiCaAlF₆, LiF/ZnS, LiBaF₃, or Li₆Gd(BO₃)₃ emits light having a wavelength of about 190 to 450 nm, as the photo detector 12a converting the emitted light from the radiation-light converter 11 to the electrical signal, a photomultiplier tube (PMT), a semiconductor photodiode, a photodiode array, a Geiger mode parallel readout APD pixel array, or the like, capable of converting light having a wavelength of about 190 to 450 nm to the electrical signal can be used. The photo detector 12a is required to have characteristics such that, when the photo detector receives a pulse having the first waveform, providing a first electrical signal corresponding to the first waveform, and, when the photo detector receives another pulse of the second waveform, providing a second electrical signal corresponding to the second waveform. It is ideal to have device performance where linearity is maintained in the input and output of the photo detector 12a.

As illustrated in FIG. 3, the radiation-light converter 11 is attached to a window of the photo detector 12a, and the photo detector 12a is established by an upper protrusion of a housing 21. A circuit board 23 connected to the output of the photo detector 12a through cables 31a and 31b, the analog amplifier 13 and a high-voltage power supply 22 which are mounted on the circuit board 23, a circuit board 24 connected to the circuit board 23 through cables 32a, 32b, and 32c, and the AD converter 14 and the signal processing circuit 15 which are mounted on the circuit board 24 are installed in the housing 21. The high-voltage power supply 22 are electrically connected to the cables 31a and 31b through buried interconnections in the circuit board 23 or surface interconnections on the circuit board 23. And furthermore, the AD converter 14 and the signal processing circuit 15 are electrically connected to the cables 32a, 32b, and 32c, through buried interconnections in the circuit board 24 or surface interconnections on the circuit board 24.

In FIG. 3, exemplarily, the housing 21 has a rectangular parallelepiped shape, and the display device 16 is attached on an upper portion of one side surface of the housing 21. The shape of the housing 21 is not limited to the rectangular parallelepiped shape, but other shapes such as a cylindrical shape may be used. In the case of a cylindrical housing 21, a structure where a portion of a circumferential surface of the housing 21 is flattened and the display device 16 is buried or a topology where a portion of the circumferential surface of the housing 21 protrudes may be used.

Adjustment knobs 34a, 34b, 34c, and 34d, configured to set conditions of the signal processing circuit 15 are provided to the bottom surface of the housing 21. A hole is cut in the bottom surface of the housing 21, and a communication cable 33, which is connected to the signal processing circuit 15 through buried interconnections in the circuit board 24 or surface interconnections on the circuit board 24, is extracted from the hole to the outside of the housing 21.

Although not illustrated in FIG. 3, the system organization including the data storage device 18 and the program storage device 19 of FIG. 1 is merely an exemplary one. For example, the data storage device 18 may exist as an internal structure in the AD converter 14 or the signal processing circuit 15 illustrated in FIG. 3, in terms of a physical structure. Furthermore, as the physical structure, the data storage device 18 may be established by a distributed configuration of internal memories in the signal processing circuit 15, such that some memory functions are implemented by registers or the like, and the remaining functions can be executed by external memories mounted on the circuit board 24. Alternatively, in terms of the physical structure, only the external memory mounted on the circuit board 24 may be assigned as the data storage device 18, or the data storage device 18 which are connected through the communication cable 33, being arranged outside the housing 21, may be included in the system organization.

Similarly, with respect to the program storage device 19 of FIG. 1, the program storage device may exist as an internal structure in the signal processing circuit 15 or the control circuit 17, etc. The program storage device may include both of a storage device as an internal memory and a storage device as an external memory of the signal processing circuit 15 or the control circuit 17. Alternatively, the program storage device may exist only as an external memory.

Furthermore, with respect to the control circuit 17 illustrated in FIG. 1, at least a portion of the functions of the control circuit 17 can be distributed, so that, in terms of an actual physical structure of the control circuit 17, the control circuit 17 may exist as an internal components in the housing 21. In some cases, various physical structures of the control circuit 17 may be implemented by an internal structure of the signal processing circuit 15. Or reversely, by monolithically integrating the signal processing circuit 15 or the AD converter 14 so as to form an array of functional blocks on a semiconductor chip as an internal structure of the control circuit 17, the control circuit 17 can be established.

As illustrated in FIG. 3, since the waveform discrimination device according to the first embodiment has a simple configuration, the device can be miniaturized in size, and the waveform discrimination device can be implemented by embedded processors in various equipment such as a micro controller unit (MCU). The MCU is built by a computer system including the analog amplifier 13, the AD converter 14, the signal processing circuit 15, the control circuit 17, and the like illustrated in FIG. 1, which are merged in a single semiconductor chip so as to form an integrated circuit. As the MCU can be considered to be lying in a category of microprocessors, addressing to self-sufficiency and low price performances, the MCU will serve as a computer implemented by a single semiconductor chip. If the waveform discrimination device is implemented by the MCU, in comparison with a general-purpose CPU, the number of peripheral parts may be lowered, and thus, it is easy to assemble the waveform discrimination device according to the first embodiment with a compact size.

As illustrated in FIG. 2, an input terminal I of the analog amplifier 13 is connected to the output side of the photo detector 12a with such a configuration that a signal output terminal and a reference potential terminal of the photo detector 12a are connected between the input terminal I of the analog amplifier 13 and the ground terminal, respectively. The input terminal I of the analog amplifier 13 is connected to the non-inverting terminal of the first operational amplifier U1 implementing the input stage of the analog amplifier 13, and an input resistor R1 is connected between the input terminal I of the analog amplifier 13 and the ground terminal. The value of the input resistor R1 connected between the input terminal I and the ground terminal of a circuit having a reference potential of an output current of the photo detector 12a is preferably 5 kΩ or more, and for example, the input resistor R1 is preferably set to have a larger value of about 50 kΩ to about 1 MΩ. Typically, since the input resistance (Imp) of an operational amplifier used as an analog amplifier is in a range of 10 MΩ to 1 TΩ, the maximum value of the input resistor R1 may be determined in consideration of the input resistance of the first operational amplifier U1 implementing the input stage of the analog amplifier 13. The inverting-input terminal of the first operational amplifier U1 is grounded through a bias compensation resistor R6. The inverting-input terminal of the first operational amplifier U1 is further connected to the output terminal of the first operational amplifier U1 through a feedback resistor R5. The output terminal of the first operational amplifier U1 is further connected to the inverting-input terminal of the second operational amplifier U2 through a transfer resistor R2, and the inverting-input terminal of the second operational amplifier U2 is connected to the output terminal of the second operational amplifier U2 through a feedback resistor R3.

The output terminal of the second operational amplifier U2 is further connected to the non-inverting terminal of the third operational amplifier U3 implementing the output stage of the analog amplifier 13 through a transfer resistor R4, and the inverting-input terminal of the second operational amplifier U2 is directly connected to the output terminal of the third operational amplifier U3, and the output terminal of the third operational amplifier U3 serves as the output terminal O of the analog amplifier 13.

By building up the circuit of the analog amplifier 13 illustrated in FIG. 2, in the waveform discrimination device according to the first embodiment, the light converted by the radiation-light converter 11 can be sequentially converted to the first or second electrical signal by the photo detector 12a, and the analog amplifier 13 can perform conversion and amplification of the first or second electrical signal to a corresponding first or second voltage signal.

In FIG. 2, by setting the value of the input resistor R1 to a larger value of, for example, about 50 kΩ, the value of an attenuation time constant τ=R1·Cp according to a capacitance Cp between the output terminal of the photo detector 12a and the input resistor R1 of the analog amplifier 13 is set to a larger value, the transient waveform is expanded along the time-domain axis, and high-frequency components of the second waveform (neutron ray) and the first waveform (gamma ray) which are desired to be discriminated can be shifted to a lower frequency band.

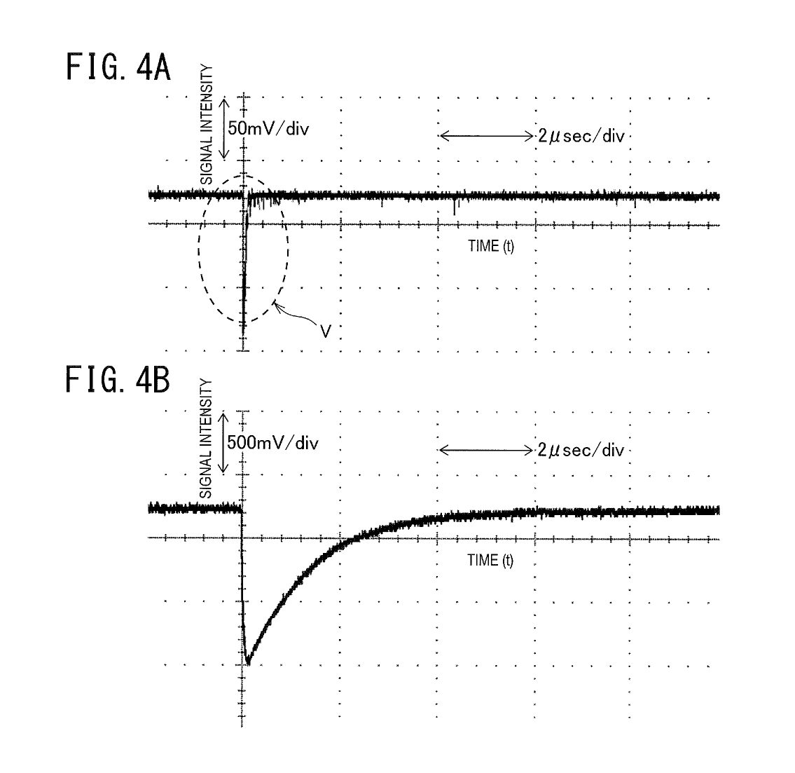

FIG. 4A illustrates a pulse waveform of the first electrical signal delivered from the photo detector 12a caused by incidence of light of the first waveform (gamma ray) to the photo detector 12a in a case where the output terminals of the photo detector 12a are terminated with 50Ω. In a case where the output terminals of the photo detector 12a are terminated with 50 kΩ, it can be understood that, in comparison with the output terminals of the photo detector are terminated with 50Ω, as illustrated in FIG. 4B, the transient waveform is expanded with about 1000 times in the time-domain axis direction.

FIG. 5 is a diagram illustrating the pulse waveform which is indicated by a portion V of the first electrical signal of FIG. 4A by expanding the time-domain axis, and the pulse waveform of the second electrical signal is also illustrated by using the common time-domain axis for comparison. FIG. 5 illustrates the pulse waveforms of the first and second electrical signals in a case where a crystal of LiCaAlF₆ doped with Ce is used as the radiation-light converter (scintillator) 11 and the light emission of the radiation-light converter 11 is detected by the photo detector (photomultiplier tube) 12a.

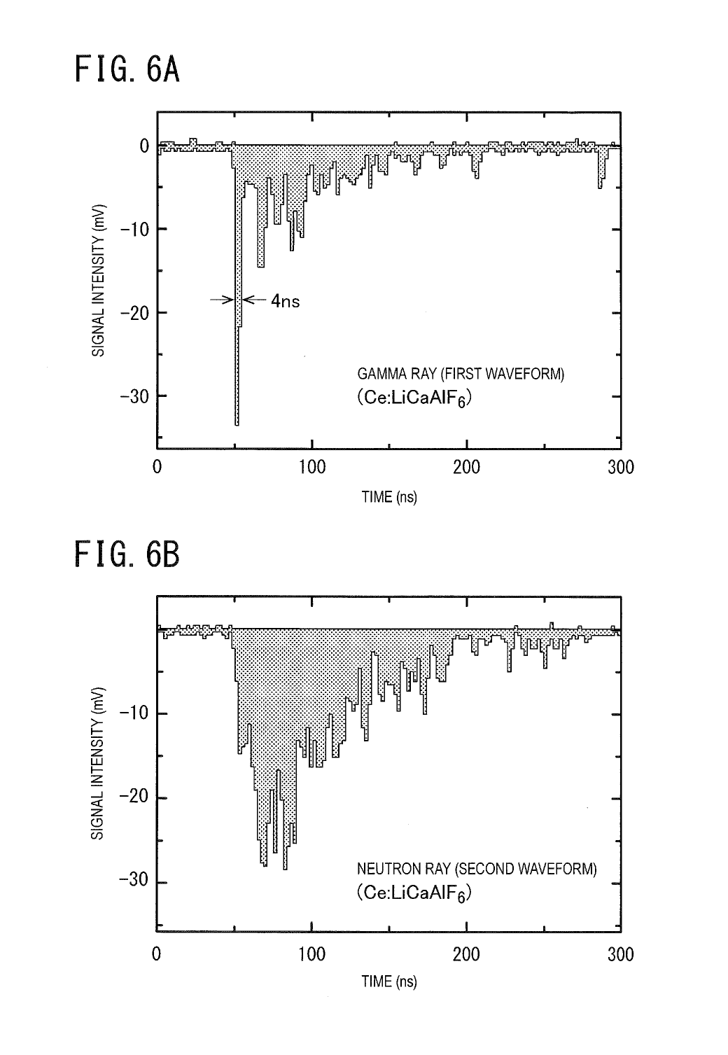

FIG. 6A is a diagram illustrating the pulse waveform indicated in the portion V of the first electrical signal of FIG. 4A by expanding the time-domain axis similarly to FIG. 5. It can be understood that, as illustrated in FIG. 6A, the first waveform (gamma ray) has two portions of a steeple portion representing a steep rise/fall characteristic where the waveform has a half width of about four nanoseconds and a hill-shaped portion representing a rise/fall characteristic where the waveform is gently sloped after the steeple portion rises. FIG. 6B illustrates the pulse waveform of the second electrical signal by using the common time-domain axis together with FIG. 6A for comparison with FIG. 6A. It can be understood that the second electrical signal has no steeple portion representing such a steep rise/fall characteristic as illustrated in FIG. 6A.

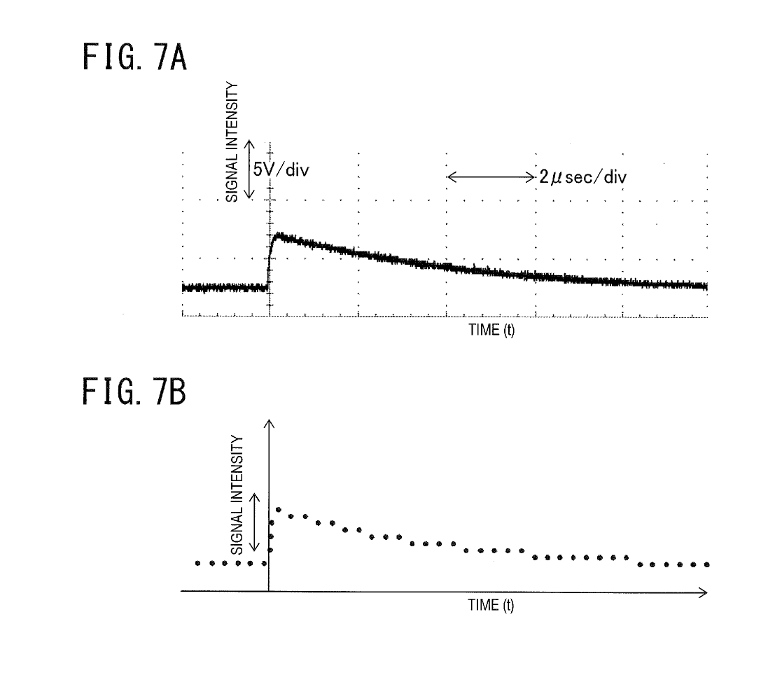

In the waveform discrimination device according to the first embodiment, since the value of the input resistor R1 of the analog amplifier 13 is set to be a larger value of about 50 kΩ and, thus, the value of the attenuation time constant τ=R1·Cp is set to be a larger value, the analog amplifier 13 expands the transient waveform of the first electrical signal of FIG. 4A along the time-domain axis so that the fall time becomes about two microseconds or more as illustrated in FIG. 7A. Namely, due to the analog amplifier 13, the general-purpose AD converter 14 converts at least one of the first and second electrical signals to a digitization capable signal as illustrated in FIG. 7B.

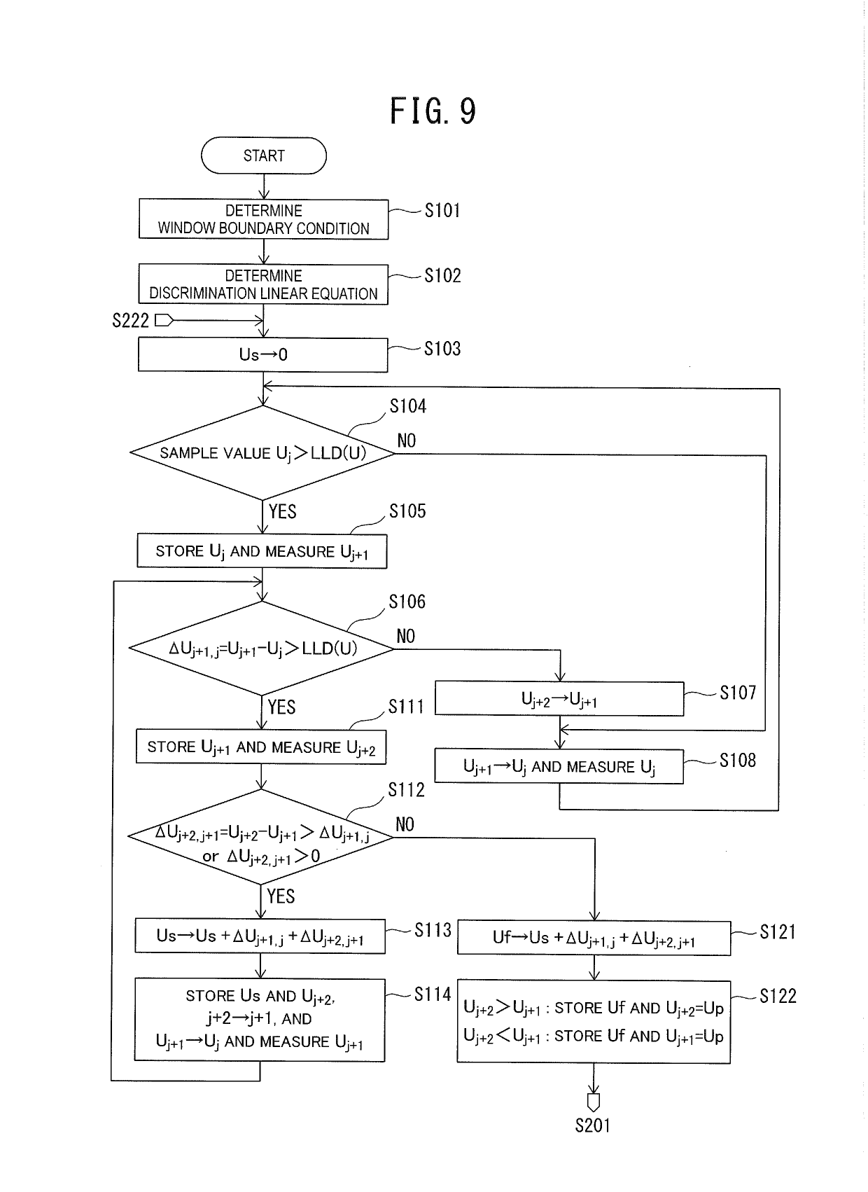

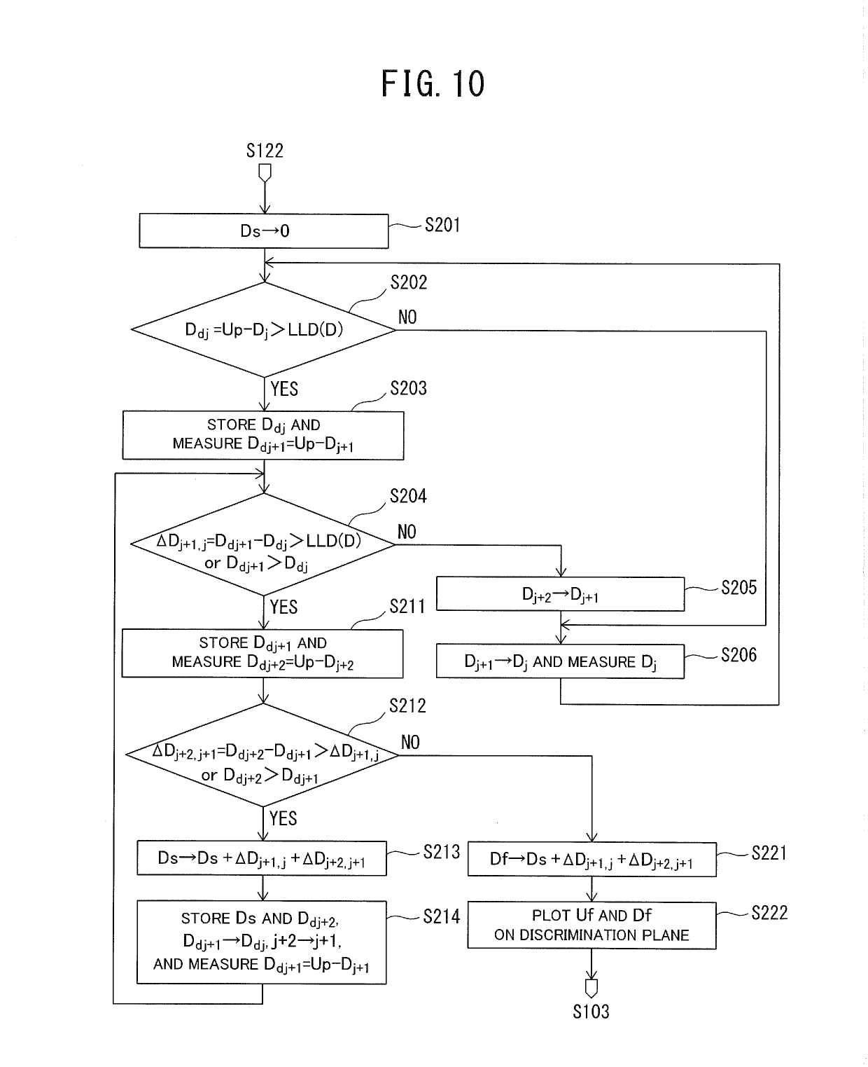

The AD converter 14 acquires a difference in attenuation time between the first and second electrical signal as well as peak values of the first and second electrical signal. The signal processing circuit 15 connected to the AD converter 14 sequentially generates coordinate points on the discrimination plane illustrated in FIG. 12 according to a flowchart illustrated FIGS. 9 and 10 to produce a two-dimensional distribution. As illustrated in FIG. 12, an area of the two-dimensional distribution is determined from a difference in correlation between two axes defined as the first and second coordinate axes, and since difference in rise characteristic and fall characteristic between the first waveform (gamma ray) and the second waveform (neutron ray) can be determined, the first waveform (gamma ray) and the second waveform (neutron ray) can be discriminated.

As illustrated in FIG. 13, the signal processing circuit 15 of the waveform discrimination device according to the first embodiment encompasses, as a functional block in the logical organization of hardware resources, a window boundary condition determination circuit 151 which transfers a calibration waveform to the waveform detector 12 so as to determine a window boundary condition required for waveform discrimination, before execution of the processes illustrated in FIGS. 9 and 10. The signal processing circuit 15 further encompasses, as another functional block, a linear equation determination circuit 152 which transfers the calibration waveform to the waveform detector 12 so as to determine a linear equation required for waveform discrimination, similarly before execution of the processes illustrated in FIGS. 9 and 10. The signal processing circuit 15 still further encompasses, as the functional blocks, a difference value calculation circuit 153 which calculates a difference between two consecutive values of discrete sets of data, defined by a certain interval generated by the AD converter 14, an attenuation amount calculation circuit 154 which calculates an attenuation amount from a peak value of a waveform established in a rise time of a discrimination object signal, in a period of fall time of the discrimination object signal, a difference value integration circuit 155 which integrates the difference value delivered by the difference value calculation circuit 153, a two-dimensional coordinate plotting circuit 156 which plots coordinate values obtained according to the processes of the flowchart illustrated in FIGS. 9 and 10 in a two-dimensional space, an arithmetic-operation proceeding determination circuit 157 which determines proceeding sates of the arithmetic operations involved with the processes of the flowchart illustrated in FIGS. 9 and 10 so as to determine a direction of branching, a waveform discrimination determination circuit 158 which discriminates and determines the waveform from a distribution of the coordinate points plotted in the two-dimensional space, a waveform-points accumulation circuit 159 which accumulates waveform points determined by the waveform discrimination determination circuit 158, a cumulative number display instruction circuit 160 which instructs a cumulative number counted by the waveform-points accumulation circuit 159 to be displayed. The signal processing circuit 15 yet still further encompasses, as the functional block, a program counter 161, which controls the degree of the to-be-executed instruction, being executed in the signal processing circuit 15, by storing the to-be-executed instruction in the program storage device 19 illustrated in FIG. 1, or alternatively, stores a set of addresses on the program storage device 19 so as to facilitate current executions by the signal processing circuit 15. The signal processing circuit 15 yet still further encompasses, as the functional blocks, a data acquisition circuit 162 which acquires data from the AD converter 14, and a peak value determination circuit 163 which determines a peak value of the discrimination object signal.

As illustrated in FIG. 13, the window boundary condition determination circuit 151, the linear equation determination circuit 152, the difference value calculation circuit 153, the attenuation amount calculation circuit 154, the difference value integration circuit 155, the two-dimensional coordinate plotting circuit 156, the arithmetic-operation proceeding determination circuit 157, the waveform discrimination determination circuit 158, the waveform-points accumulation circuit 159, the cumulative number display instruction circuit 160, the program counter 161, the data acquisition circuit 162, and the peak value determination circuit 163 are connected to each other via a data bus 164. The window boundary condition determination circuit 151, the linear equation determination circuit 152, the difference value calculation circuit 153, the attenuation amount calculation circuit 154, the difference value integration circuit 155, the two-dimensional coordinate plotting circuit 156, the arithmetic-operation proceeding determination circuit 157, the waveform discrimination determination circuit 158, the waveform-points accumulation circuit 159, the cumulative number display instruction circuit 160, the program counter 161, the data acquisition circuit 162, and the peak value determination circuit 163 illustrated in FIG. 13 are expressed as pro forma hardware resources by focusing on logical functions. These pro forma components do not necessarily represent functional blocks existing independently as physical regions on a semiconductor chip, but in an actual case, the existence of the configuration is not always negated.

Although not illustrated in FIGS. 1 and 13, the waveform discrimination device according to the first embodiment may further include an input unit configured to receive an input signal such as data or instructions from an operational personnel, an output unit configured to transfer a discrimination result, and the like. The input unit is embodied by a keyboard, a mouse, a write pen, a flexible disk device, or the like. By using the input unit, the executing personnel in charge of waveform discrimination can indicate input/output data or determine individual numeric values, a value of tolerance, an extent of error required for waveform discrimination. Furthermore, by using the input unit, the executing personnel may define analyzing parameters such as an output data format, and may provide instructions such as executing or stopping of the arithmetic operation. In addition, each of the output unit and the display device 16 may be embodied by a printer or a display unit.

According to the waveform discrimination device according to the first embodiment, the waveform discrimination device can be embodied by the simple, inexpensive hardware resources illustrated in FIGS. 1 to 3 and 13, and thus, main components of the waveform discrimination device can be integrated on a small-sized circuit board, so that the entire structure of the waveform discrimination device can be miniaturized. Therefore, it is possible to achieve effectiveness that the waveform discrimination device can be easily embodied by portable structures.

Particularly, in the field of radiation measurement applications, in an earlier system organization of the invention disclosed in Non-PTL 1, there is a problem of counting error caused by a transient characteristic (slew rate) of a charge-sensitive preamplifier used for the earlier system organization. According to the waveform discrimination device according to the first embodiment, it is possible to achieve a remarkable effectiveness that the problem of counting error caused by the charge-sensitive preamplifier can be avoided.

(Generation of Two-Dimensional Distribution)

With reference to FIGS. 9 to 13, a method of generating the two-dimensional distribution which is a basis of the waveform discrimination method according to the first embodiment of the present invention will be explained. In addition, the method of generating the two-dimensional distribution described hereinafter is an exemplary one. It should be noted that, within the scope of the spirit disclosed in the claims, modified examples thereof are included, and other various methods of generating the two-dimensional distribution can be implemented.

In step S101 of FIG. 9, the window boundary condition determination circuit 151 of the signal processing circuit 15 illustrated in FIG. 13 determines a discrimination window boundary condition, the program counter 161 counts an address of instruction subsequently read out from the program storage device 19, and the process of the signal processing circuit 15 proceeds to step S102. In step S102 of FIG. 9, the linear equation determination circuit 152 of the signal processing circuit 15 illustrated in FIG. 13 determines a discrimination linear equation, and the program counter 161 allows the process of the signal processing circuit 15 to proceed to step S103.

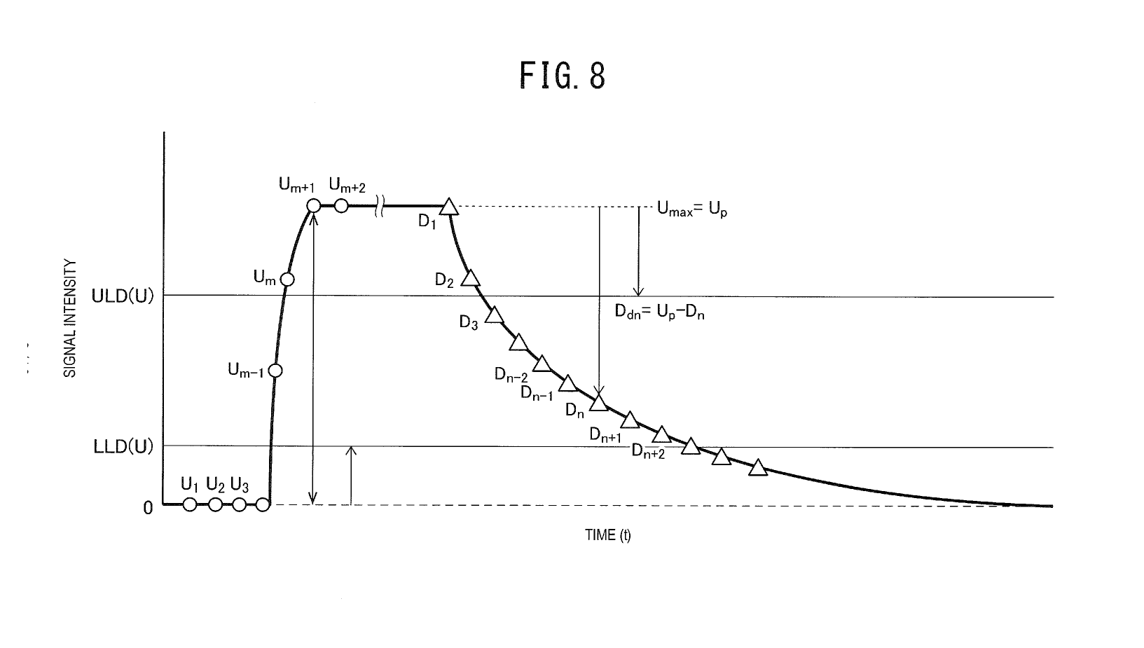

In step S103, the arithmetic-operation proceeding determination circuit 157 of the signal processing circuit 15 illustrated in FIG. 13 resets a characteristic-amount Us of the rise time and stores the value of the characteristic-amount Us=0 in the data storage device 18 illustrated in FIG. 13. After that, by the program counter 161, the process of the signal processing circuit 15 proceeds to step S104. In step S104, the arithmetic-operation proceeding determination circuit 157 reads out a sample value Uⱼ of the discrimination object signal from the data storage device 18 and determines whether or not the sample value Uⱼ is larger than a lower limit identification value LLD(U) of the characteristic-amount of the rise time. In the example of FIG. 8, j=m−1 is set, and the arithmetic-operation proceeding determination circuit 157 determines whether or not a sample value Uₘ is larger than the lower limit identification value LLD(U) of the characteristic-amount of the rise time.

Since the operations of the signal processing circuit 15 illustrated in the flowchart of FIGS. 9 and 10 proceed in real time at the time when a pulse included in a first pulse group or a pulse included in a second pulse group is transferred to the waveform detector 12 at arbitrary timing and at least one of the first and second electrical signals is transmitted as the discrimination object signal from the waveform detector 12 at arbitrary timing, the process of the arithmetic-operation proceeding determination circuit 157, which reads out the sample value Uⱼ stored in the data storage device 18 in step S104, may be performed so that the output of the AD converter 14 is directly acquired by the arithmetic-operation proceeding determination circuit 157 without using the data storage device 18.

In a case where it is determined in step S104 that the sample value Uⱼ is larger than the lower limit identification value LLD(U) of the characteristic-amount of the rise time, the process proceeds to step S105 where the sample value Uⱼ is stored in the data storage device 18 illustrated in FIG. 13. As the data storage device 18, a register or the like of the microprocessor (MPU) may be used. In step S105, furthermore, the difference value calculation circuit 153 reads out a sample value Uⱼ₊₁ stored in the data storage device 18, and the process proceeds to step S106. As described above, since the operations of the signal processing circuit 15 proceed in real time at the same time of measurement, the process of the difference value calculation circuit 153, which reads out the sample value Uⱼ₊₁ stored in the data storage device 18 in step S105, may be performed so that the sample value U₁₊₁ is directly received from the AD converter 14 by the difference value integration circuit 153 without using the data storage device 18 according to the timing where the waveform detector 12 measures the first waveform or the second waveform.

In step S104, in a case where it is determined that the sample value Uⱼ is not larger than the lower limit identification value LLD(U) of the characteristic-amount of the rise time, the process proceeds to step S108. In step S108, the next sample value Uⱼ₊₁ stored in the data storage device 18 is replaced with a new sample value Uⱼ, and the new sample value Uⱼ is acquired by the arithmetic-operation proceeding determination circuit 157. The process of the signal processing circuit 15 returns to the step S104.

In step S106, the difference value calculation circuit 153 reads out the sample value Uⱼ stored in the data storage device 18, calculates a difference value ΔU_{j+1,j}=Uⱼ₊₁−Uⱼ, and transmits the calculation result to the arithmetic-operation proceeding determination circuit 157. In the example of j=m of FIG. 8, the difference value integration circuit calculates a difference value ΔU_{m+1,m}=Uₘ₊₁−Uₘ, and transmits the calculation result to the arithmetic-operation proceeding determination circuit 157. In step S106, the arithmetic-operation proceeding determination circuit 157 determines whether or not the difference value ΔU_{j+1,j} is larger than the lower limit identification value LLD(U) of the characteristic-amount of the rise time.

In a case where it is determined in step S106 that the difference value ΔU_{j+1,j} of the discrimination object signal is larger than the lower limit identification value LLD(U) of the characteristic-amount of the rise time, the process proceeds to step S111 where the sample value Uⱼ₊₁ and the difference value ΔU_{j+1,j} are stored in the data storage device 18. In step S111, furthermore, the difference value calculation circuit 153 reads out a sample value Uⱼ₊₂ stored in the data storage device 18, and the process proceeds to step S112. Since the operations of the signal processing circuit 15 proceed in real time at the same time of measurement, the process of the difference value calculation circuit 153, which reads out the sample value Uⱼ₊₂ stored in the data storage device 18 in step S111, is performed so that the sample value Uⱼ₊₁ is directly received from the AD converter 14 by the difference value calculation circuit 153 without using the data storage device 18 according to the timing when the first waveform or the second waveform is measured.

In a case where it is determined in step S106 that the difference value ΔU_{j+1,j} is not larger than the lower limit identification value LLD(U) of the characteristic-amount of the rise time, the process proceeds to step S107. In step S107, the next sample value Uⱼ₊₂ stored in the data storage device 18 is replaced with a new sample value Uⱼ₊₁, and the process proceeds to step S108. In step S108, the sample value Uⱼ₊₁ stored in the data storage device 18 is replaced with a sample value Uⱼ, the new sample value Uⱼ is acquired by the arithmetic-operation proceeding determination circuit 157, and the process returns to step S104.

In step S112, the difference value calculation circuit 153 reads out the sample value Uⱼ₊₁ stored in the data storage device 18, calculates a difference value ΔU_{j+2,j+1}=Uⱼ₊₂−Uⱼ₊₁, and transmits the calculation result to the arithmetic-operation proceeding determination circuit 157. In step S112, the arithmetic-operation proceeding determination circuit 157 reads out the difference value ΔU_{j+1,j} stored in the data storage device 18 and determines whether or not the difference value ΔU_{j+2,j+1} delivered by the difference value calculation circuit 153 is larger than the difference value ΔU_{j+1,j} or whether or not the difference value ΔU_{j+2,j+1} is a positive value. In a case where one of the condition that the difference value ΔU_{j+2,j+1} is larger than difference value ΔU_{j+1,j} and the condition that the difference value ΔU_{j+2,j+1} is a positive value is satisfied in step S112, the difference value ΔU_{j+2,j+1} is fed to the difference value calculation circuit 153 of the signal processing circuit 15, and the process proceeds to step S113. On the other hand, in a case where any one of the condition that the difference value ΔU_{j+2,j+1} is larger than difference value ΔU_{j+1,j} and the condition that the difference value ΔU_{j+2,j+1} is a positive value is not satisfied in step S112, the difference value ΔU_{j+2,j+1} and the difference value ΔU_{j+1,j} are simultaneously or sequentially transferred to the difference value calculation circuit 153, and the process proceeds to step S121.

In step S113, the difference value calculation circuit 153 of the signal processing circuit 15 reads out the characteristic-amount Us and the difference value ΔU_{j+1,j} from the data storage device 18, calculates a value of Us+ΔU_{j+1,j}+ΔU_{j+2,j+1}, sets the calculation result as a new characteristic-amount Us, and the process proceeds to step S114.

In step S114, the difference value calculation circuit 153 stores the value (=Us+ΔU_{j+1,j}+ΔU_{j+2,j+1}) of the new characteristic-amount Us and the sample value Uⱼ₊₂ in the data storage device 18. In step S114, the program counter 161 places back the address of instruction, which will subsequently be read out from the program storage device 19, from j+2 to j+1, and further replaces the address of the next sample value Uⱼ₊₁ stored in the data storage device 18 with an address of a new sample value Uⱼ. Then, the arithmetic-operation proceeding determination circuit 157 reads out a new sample value Uⱼ₊₁ from the data storage device 18, and the process returns to step S106.

In step S121, the difference value calculation circuit 153 reads out the characteristic-amount Us from the data storage device 18, calculates the value of Us+ΔU_{j+1,j}+ΔU_{j+2,j+1} as a value Uf of the first coordinate axis, and the process proceeds to step S122. In step S122, the peak value determination circuit 163 of the signal processing circuit 15 reads out the sample value Uⱼ₊₁ and the sample value Uⱼ₊₂ stored in the data storage device 18, and compares the magnitudes of the sample value Uⱼ₊₁ and the sample value Uⱼ₊₂. In a case where the peak value determination circuit 163 determines that Uⱼ₊₂>Uⱼ₊₁, it is determined that the value of the sample value Uⱼ₊₂ is a peak value Up, the value of the peak value Up=Uⱼ₊₂ and the value Uf of the first coordinate axis determined by the difference value calculation circuit 153 are stored in the data storage device 18, and the process proceeds to step S201. In a case where the peak value determination circuit 163 determines that Uⱼ₊₂<Uⱼ₊₁, the value of the sample value Uⱼ₊₁ is a peak value Up, and the value of the peak value Up=Uⱼ₊₁ is stored in the data storage device 18. In addition, the difference value calculation circuit 153 corrects the value Uf of the first coordinate axis determined in step S121 by using Uf=Us+ΔU_{j+1,j} and stores the corrected value Uf in the data storage device 18, and the process proceeds to step S201.

In step S201 of FIG. 10, the arithmetic-operation proceeding determination circuit 157 resets a characteristic-amount Ds of the fall time, and stores the value of the characteristic-amount Ds=0 in the data storage device 18. After that, the program counter 161 counts the address of instruction, which will subsequently be read out from the program storage device 19, and the process proceeds to step S202. In step S202, the attenuation amount calculation circuit 154 reads out a sample value Dⱼ and the peak value Up from the data storage device 18, calculates an attenuation amount D_{dj}=Up−Dⱼ, and transmits the attenuation amount D_{dj} to the arithmetic-operation proceeding determination circuit 157. In FIG. 8, as an example, definition is illustrated in a case where j=n, and it is illustrated that an attenuation amount D_{dn}=Up−Dₙ is calculated with respect to the peak value Up=Uₘₐₓ.

In addition, since the operations of the signal processing circuit 15 proceed in real time at the same time of measurement by the waveform detector 12, the process of the attenuation amount calculation circuit 154, which reads out the sample value Dⱼ stored in the data storage device 18 in step S202, is performed so that the sample value Dⱼ is directly received from the AD converter 14 by the attenuation amount calculation circuit 154 without using the data storage device 18 according to the timing when the first waveform or the second waveform is measured.

In step S202, the arithmetic-operation proceeding determination circuit 157 determines whether or not the attenuation amount D_{dj} is larger than a lower limit identification value LLD(D) of the characteristic-amount of the fall time. In a case where it is determined in step S202 that the attenuation amount D_{dj} is larger than the lower limit identification value LLD(D) of the characteristic-amount of the fall time, the process proceeds to step S203, where the attenuation amount D_{dj} is stored in the data storage device 18.

In step S203, furthermore, the attenuation amount calculation circuit 154 reads out the sample value Dⱼ₊₁ and the peak value Up from the data storage device 18, calculates the attenuation amount D_{dj+1}=Up−Dⱼ₊₁, and the process proceeds to step S204. The process of the attenuation amount calculation circuit 154, which reads out the sample value Dⱼ₊₁ stored in the data storage device 18 in step S203, is performed so that the sample value Dⱼ₊₁ is directly received from the AD converter 14 by the attenuation amount calculation circuit 154 according to the timing when the first waveform or the second waveform is measured without using the data storage device 18.

In a case where it is determined in step S202 that the attenuation amount D_{dj} is not larger than the lower limit identification value LLD(D) of the characteristic-amount of the fall time, the process proceeds to step S206. In step S206, the next sample value Dⱼ₊₁ stored in the data storage device 18 is replaced with a new sample value Dⱼ, the new sample value Dⱼ is acquired by the attenuation amount calculation circuit 154, and the process of the signal processing circuit 15 returns to step S202.

In step S204, the difference value calculation circuit 153 reads out the attenuation amount D_{dj} stored in the data storage device 18, calculates a difference value ΔD_{j+1,j}=D_{dj+1}−D_{dj} between the attenuation amounts, and transmits the calculation result to the arithmetic-operation proceeding determination circuit 157. In step S204, the arithmetic-operation proceeding determination circuit 157 determines whether or not the difference value ΔD_{j+1,j} between the attenuation amounts is larger than the lower limit identification value LLD(D) of the characteristic-amount of the fall time or whether or not the attenuation amount D_{dj+1} is larger than the attenuation amount D_{dj}.

In a case where it is determined in step S204 that the difference value ΔD_{j+1,j} between the attenuation amounts is larger than the lower limit identification value LLD(D) of the characteristic-amount of the fall time, or it is determined that the attenuation amount D_{dj+1} is larger than the attenuation amount D_{dj}, the process proceeds to step S211 where the attenuation amount D_{dj+1} and the difference value ΔD_{j+1,j} between the attenuation amounts is stored in the data storage device 18. In step S211, furthermore, the attenuation amount calculation circuit 154 reads out the sample value Dⱼ₊₂ and the peak value Dp from the data storage device 18, calculates the attenuation amount D_{dj+2}=Up−Dⱼ₊₂, and the process proceeds to step S212. The process of the attenuation amount calculation circuit 154, which reads out the sample value Dⱼ₊₂ stored in the data storage device 18 in step S211, may be performed so that the sample value Dⱼ₊₂ is directly received from the AD converter 14 by the attenuation amount calculation circuit 154 without using the data storage device 18 at the timing when the first waveform or the second waveform is measured.

In a case where it is determined in step S204 that the difference value ΔD_{j+1,j} between the attenuation amounts is not larger than the lower limit identification value LLD(D) of the characteristic-amount of the fall time, or it is determined that the attenuation amount D_{dj+1} is not larger than the attenuation amount D_{dj}, the process proceeds to step S205. In step S205, the next sample value Dⱼ₊₂ stored in the data storage device 18 is replaced with a new sample value Dⱼ₊₁, and the process proceeds to step S206. In step S206, the sample value Dⱼ₊₁ stored in the data storage device 18 is replaced with a sample value Dⱼ, the new sample value Dⱼ is acquired by the attenuation amount calculation circuit 154, and the process returns to step S202.

In step S212, the difference value integration circuit 153 calculates the difference value ΔD_{j+2,j}=D_{dj+2}−D_{dj+1} between the attenuation amounts and determines whether or not the difference value ΔD_{j+2,j+1} between the attenuation amounts is larger than the difference value ΔD_{j+1,j} between the attenuation amounts or whether or not the attenuation amount D_{dj+2} is larger than the attenuation amount D_{dj+1}. In a case where one of the condition that the difference value ΔD_{j+2,j+1} between the attenuation amounts is larger than the difference value ΔD_{j+1,j} between the attenuation amounts and the condition that the attenuation amount D_{dj+2} is larger than the attenuation amount D_{dj+1} is satisfied in step S212, the difference value ΔD_{j+2,j+1} between the attenuation amounts is fed to the difference value integration circuit 153, and the process proceeds to step S213.

On the other hand, in a case where any one of the condition that:

(a) the difference value ΔD_{j+2,j+1} between the attenuation amounts is larger than the difference value ΔD_{j+1,j} between the attenuation amounts; and

(b) the attenuation amount D_{dj+2} is larger than the attenuation amount D_{dj+1},

is not satisfied in step S212, the difference values ΔD_{j+2,j+1} and ΔD_{j+1,j} between the attenuation amounts are simultaneously or sequentially transferred to the difference value calculation circuit 153, and the process proceeds to step S221.

In step S213, the difference value calculation circuit 153 reads out the characteristic-amount Ds and the difference value ΔD_{j+1,j}, between the attenuation amounts from the data storage device 18, calculates the value of Ds+ΔD_{j+1,j}+ΔD_{j+2,j+1}, sets the calculation result as a new characteristic-amount Ds, and the process proceeds to step S214. In step S214, the difference value calculation circuit 153 stores the value (=Ds+ΔD_{j+1,j}+ΔD_{j+2,j+1}) of the new characteristic-amount Ds and the attenuation amount D_{dj+2} in the data storage device 18. In step S214, the program counter 161 places back the address of instruction, which will be subsequently read out from the program storage device 19, from j+2 to j+1 and further replaces the address of the next attenuation amount D_{dj+1} stored in the data storage device 18 with an address of a new attenuation amount D_{dj}, the attenuation amount calculation circuit 154 reads out a new sample value Dⱼ₊₁ from the data storage device 18, and the process returns to step S204.

In step S221, the difference value calculation circuit 153 reads out the characteristic-amount Ds from the data storage device 18, calculates the value of Ds+ΔD_{j+1,j}+ΔD_{j+2,j+1} as a value Df of the second coordinate axis, stores the value Df of the second coordinate axis in the data storage device 18, and the process proceeds to step S222.

In step S222, the two-dimensional coordinate plotting circuit 156 of the signal processing circuit 15 plots a point representing a coordinate (Uf, Df) implemented by a set of the value Df of the second coordinate axis and the value Uf of the first coordinate axis on the discrimination plane, which is defined by the first coordinate axis and the second coordinate axis as illustrated in FIG. 12. If the coordinate (Uf, Df) is plotted on the discrimination plane, the process returns to step S103, and the characteristic-amount Us of the rise time is reset. If the process returns to step S103, the program counter 161 synchronizes the signal processing circuit 15 with a clock signal, and the processes illustrated in the flowchart illustrated in FIGS. 9 and 10 are allowed to be executed at every moment. At the time when a pulse included in the next first pulse group or a pulse included in the second pulse group is transferred to the waveform detector 12 and at least one of the first and second electrical signals is transmitted as a discrimination object signal from the waveform detector 12, the two-dimensional coordinate plotting circuit 156 plots a new point representing a coordinate (Uf, Df) implemented by a set of the value Uf of the first coordinate axis and the value Df of the second coordinate axis on the discrimination plane, which is defined by the first coordinate axis and the second coordinate axis as illustrated in FIG. 12.

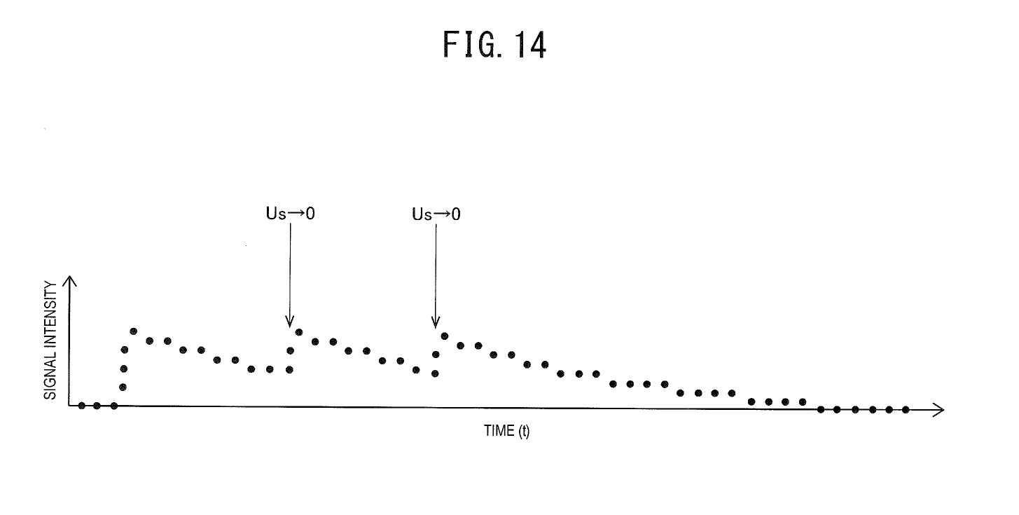

According to the waveform discrimination method according to the first embodiment, even in a case where, before the signal intensity in the fall time of the pulse waveform is fallen down to the baseline, there is an input of gamma ray or neutron ray to the radiation-light converter 11, and thus, as illustrated in FIG. 14, there occurs pile-up where a falling waveform of an electrical signal delivered from the photo detector 12a is overlapped with a rising waveform of the subsequent pulse signal, a correct peak value can be acquired.

Namely, in a case where the pile-up occurs and it is determined that in step S212 that the attenuation amount D_{dj+2} is smaller than the attenuation amount D_{dj+1}, the process returns through step S221 and step S222 to step S103. In a case where the pile-up occurs as illustrated in FIG. 14, in step S103, the arithmetic-operation proceeding determination circuit 157 resets the characteristic-amount Us of the rise time (Us=0), and the process of the signal processing circuit 15 proceeds to step S104, so that the waveform at the site of the pile-up can be measured.

FIG. 14 illustrates a case where the pile-up occurs at two sites in the falling waveform. However, every time when the pile-up occurs, since it can be determined in step S212 that the pile-up occurs, the process returns through step S221 and step S222 to step S103. In step S103, the arithmetic-operation proceeding determination circuit 157 resets the characteristic-amount Us of the rise time (Us=0), and a series of steps subsequent to the step S104 are executed, so that even in a case where the pile-up consecutively occurs, a correct waveform can be measured.

As described above, one of the technical advantages of the waveform discrimination device according to the first embodiment is that the analog amplifier 13 illustrated in FIG. 1 amplifies the transient waveform of the discrimination object signal delivered from the waveform detector 12 so as to be expanded along the time-domain axis. Since the sampling interval for allowing the AD converter 14 to acquire the digital data can be set to be long by expanding the fall time of the discrimination object signal along the time-domain axis, the waveform discrimination device according to the first embodiment facilitates employment of an inexpensive, simple AD converter 14. However, if the fall time is expanded along the time-domain axis to be too long, according to some characteristics of the physical quantities of the measured pulse, the probability of pile-up illustrated in FIG. 14 is increased, and thus, the interval of pile-up becomes too short. Therefore, the sample value required for waveform discrimination cannot be acquired, so that there is a problem in that accuracy is lowered. Therefore, the value of the input resistor R1 connected between the input terminal I of the analog amplifier 13 and the ground terminal illustrated in FIG. 2 may be appropriately selected within a range of about 5 kΩ to about 1 MΩ in accordance with the characteristics of the physical quantities of the measured pulse and may be adjusted to an optimal value. With respect to the adjustment of the value of the input resistor R1, input resistance adjustment knobs, such as the adjustment knobs 34a, 34b, 34c, and 34d provided at the bottom surface of the housing 21 illustrated in FIG. 3, will be further attached, so that the value of the input resistor R1 can be set as variable values. Then, if the adjustment is performed while viewing the characteristics of the physical quantities of the measured pulse, versatility of the waveform discrimination device according to the first embodiment can be increased.

In addition, the configuration of the waveform discrimination device for executing the waveform discrimination method according to the first embodiment is based on simple, inexpensive hardware resources illustrated in FIGS. 1 to 3 and 13, and as a result, the cost required for measurement can be maintained a low cost. In addition, the waveform discrimination device used for measurement is integrated on a small-sized circuit board, so that the waveform discrimination device can be easily embodied by portable structures. Therefore, it is possible to achieve a remarkable effectiveness that workability and operability are improved.

(Waveform Discrimination of Pulse)

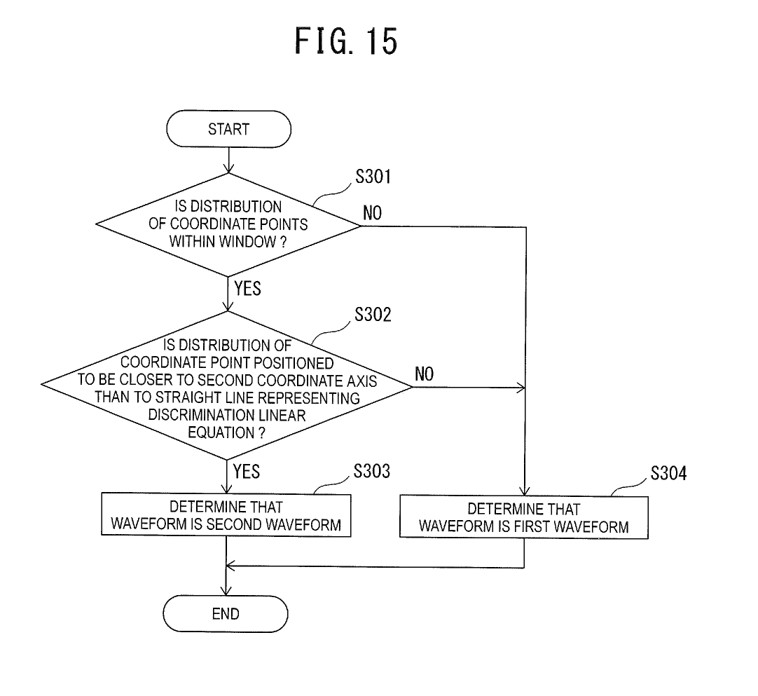

The waveform-points accumulation circuit 159 of the signal processing circuit 15 continues to repeat a feedback loop circulating from step S222 of FIG. 10 to step S103 of FIG. 9 as long as the power supply, configured to drive the signal processing circuit 15, is turned on. Since new points are sequentially accumulated on the discrimination plane according to the repetition of the loop in accordance with a series of processes illustrated in FIGS. 9 and 10, a large number of coordinate points are plotted to be locally distributed on the discrimination plane, according to the situation whether the waveform is a waveform of pulses included in the first pulse group or is a waveform of pulses included in the second pulse group. As illustrated in FIG. 12, since a plurality of the coordinate points are distributed in the localized areas on the discrimination plane, the localized areas are classified and analyzed according to the flowchart illustrated in FIG. 15, so that it can be discriminated whether the waveform corresponds to pulses included in the first pulse group, or to pulses included in the second pulse group.

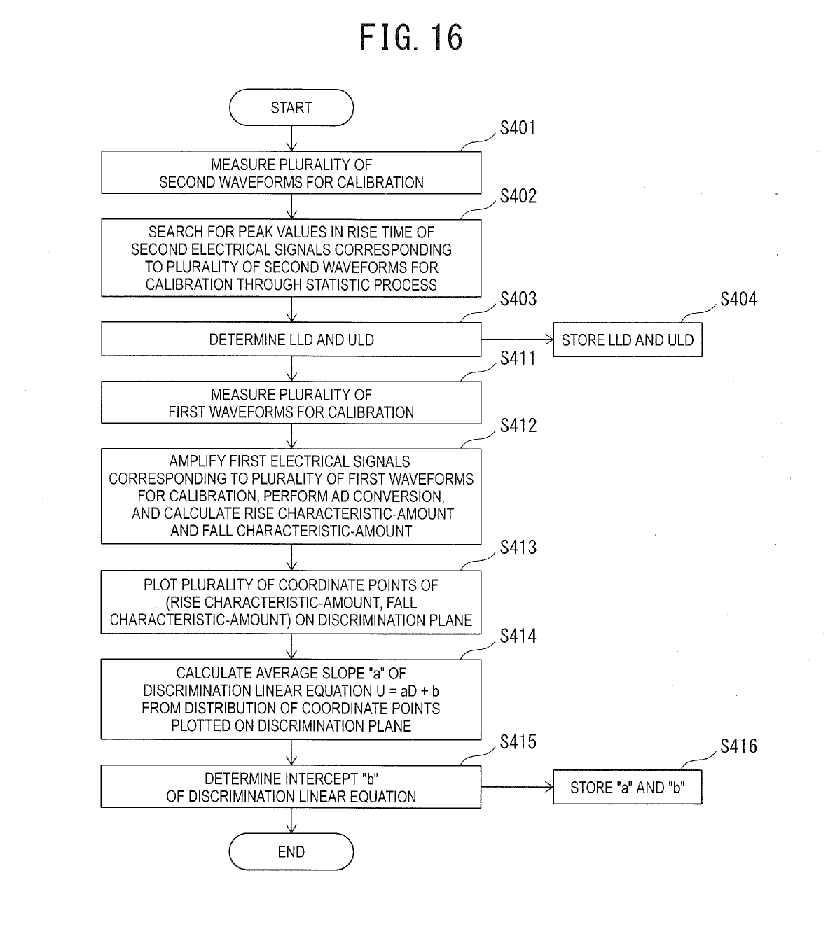

First, in step S301 of FIG. 15, the waveform discrimination determination circuit 158 of the signal processing circuit 15 illustrated in FIG. 13 determines whether or not the position of the coordinate point is a position within the discrimination window. In FIG. 12, with respect to the discrimination window, a lower limit identification value LLD(D) of the characteristic-amount Df of the fall time and an upper limit identification value ULD(D) of the characteristic-amount Df of the fall time are defined along the X axis which is the second coordinate axis, and a lower limit identification value LLD(U) of the characteristic-amount Uf of the rise time and an upper limit identification value ULD(U) of the characteristic-amount Uf of the rise time are defined along the Y axis which is the first coordinate axis. The lower limit identification value LLD(D), the upper limit identification value ULD(D), the lower limit identification value LLD(U), and the upper limit identification value ULD(U) may be determined, in advance, by the procedure illustrated in FIG. 16. Then, the lower limit identification value LLD(D), the upper limit identification value ULD(D), the lower limit identification value LLD(U), and the upper limit identification value ULD(U) may be stored in the data storage device 18, so that they may be read out from the data storage device 18 at the time of determining the position of the window. Namely, in FIG. 12, by using the data stored in the data storage device 18, the discrimination window is defined as a rectangular area surrounded by two parallel straight lines (vertical lines) which are perpendicular to the second coordinate axis and have intercepts having values of LLD(D) and ULD(D) with respect to the second coordinate axis and two parallel straight lines (horizontal lines) which are perpendicular to the first coordinate axis and have intercepts having values of LLD(U) and ULD(U) with respect to the first coordinate axis.

In step S301, the waveform discrimination determination circuit 158 determines whether or not the distribution of the coordinate points (Uf, Df) defined as a set of the value Uf of the first coordinate axis and the value Df of the second coordinate axis is positioned within the discrimination window. In a case where it is determined in step S301 the distribution of the coordinate points (Uf, Df) is not positioned within the discrimination window, in step S304, the waveform discrimination determination circuit 158 determines that the discrimination object signal delivered from the waveform detector 12 is a signal pertains to the first waveform as a generation source. On the other hand, in a case where it is determined in step S301 that the distribution of the coordinate points (Uf, Df) is positioned within the discrimination window, the process proceeds to step S302.

In step S302, the waveform discrimination determination circuit 158 determines whether or not the distribution of the coordinate points (Uf, Df) defined by a set of the value Uf of the first coordinate axis and the value Df of the second coordinate axis exists in the area which is closer to the second coordinate axis than to a straight line representing the discrimination linear equation. As illustrated in FIG. 12, the discrimination linear equation is expressed by a linear function with a slope “a” and an intercept “b” with respect to the first coordinate axis.

The values of the slope “a” and the intercept “b” of the discrimination linear equation may be determined in advance by the procedure illustrated in FIG. 16, may be stored in the data storage device 18, and may be read out from the data storage device 18 at the time of determining the position of the window. Namely, in FIG. 12, by using the values of the slope “a” and the intercept “b” stored in the data storage device 18, the discrimination linear equation is defined on the discrimination plane.

In a case where it is determined in step S301 that the distribution of the coordinate points (Uf, Df) is not positioned to be closer to the second coordinate axis than to the straight line representing the discrimination linear equation, in step S304, the waveform discrimination determination circuit 158 determines that the discrimination object signal delivered from the waveform detector 12 is a signal pertains to the first waveform as a generation source. On the other hand, in a case where is determined in step S301 that the distribution of the coordinate points (Uf, Df) is positioned to be closer to the second coordinate axis than to the straight line representing the discrimination linear equation, the process proceeds to step S303 where the waveform discrimination determination circuit 158 determines that the discrimination object signal delivered from the waveform detector 12 is a signal pertains to the second waveform as a generation source.

In this manner, it is discriminated by the position of the distribution of the coordinate points (Uf, Df) according to the flowchart illustrated in FIG. 15 whether the waveform is a waveform of pulses included in the first pulse group or a waveform of pulses included in the second pulse group, so that the waveform-points accumulation circuit 159 can count a cumulative number of the coordinates corresponding to the second waveform and a cumulative number of the coordinates corresponding to the first waveform.

The cumulative numbers of coordinates corresponding to the first and second waveforms accumulated and counted by the waveform-points accumulation circuit 159 can be displayed on the display device 16 illustrated in FIGS. 1 and 3, by the instructions from the cumulative number display instruction circuit 160 of the signal processing circuit 15. That is, to the display device 16, the cumulative number display instruction circuit 160 transmits display instruction and data required for display.

(Determination of Discrimination Window and Discrimination Linear Equation)

The inventors found that, in an application example of the waveform discrimination method according to the first embodiment discriminating waveforms of gamma ray and neutron ray as an example, as illustrated in FIG. 11, the rise characteristic-amount Uf of the gamma ray and the fall characteristic-amount Df of the gamma ray are linearly proportional to each other. On the other hand, the inventors found that, as illustrated in FIG. 11, the same relationship of linear proportion also exists between the rise characteristic-amount Uf of the neutron ray and the fall characteristic-amount Df of the gamma ray in the topology of the distribution area of the coordinate points although the relationship is weaker than that of the case of the rise characteristic-amount Uf of the gamma ray. A strong relationship of linear proportion between the rise characteristic-amount Uf and the fall characteristic-amount Df of the neutron ray is obtained in advance by using the discrimination linear equation U_{f}=aD_{f}+b, so that the first waveform and the second waveform can be accurately discriminated.

First, in step S401 of FIG. 16, the pulse included in the second pulse group for calibration, of which waveform is known, is transferred to the waveform detector 12. The second electrical signals delivered from the waveform detector 12 are sequentially transferred as the discrimination object signal from the waveform detector 12, the analog amplifier 13 expands the transient waveform of the discrimination object signal along the time-domain axis, and the AD converter 14 samples the amplified discrimination object signal and converts the discrimination object signal to digital data. In step S401, a plurality of digital data pertains to second waveforms for calibration as a generation source are sequentially fed to the window boundary condition determination circuit 151 of the signal processing circuit 15 illustrated in FIG. 13 in real time and if a plurality of the second waveforms for calibration are measured, the process proceeds to step S402.

In step S402, the window boundary condition determination circuit 151 searches for the peak values in the rise times of a plurality of the second electrical signals delivered from the waveform detector 12 corresponding to a plurality of the second waveforms for calibration through a statistic process by using the digital data which are sequentially converted by the AD converter 14, and the process proceeds to step S403.

In step S403, the window boundary condition determination circuit 151 determines the lower limit identification value LLD(D) of the characteristic-amount Df of the fall time, the upper limit identification value ULD(D) of the characteristic-amount Df of the fall time, the lower limit identification value LLD(U) of the characteristic-amount Uf of the rise time, and the upper limit identification value ULD(U) of the characteristic-amount Uf of the rise time by using the peak values in the rise times searched in step S402. In step S404, the values of LLD(D), ULD(D), LLD(U), and ULD(U) determined in step S403 are stored in the data storage device 18.

After that, by the program counter 161, the process of the signal processing circuit 15 proceeds to step S411. In step S411, the pulse included in the first pulse group for calibration, of which waveform is known, is transferred to the waveform detector 12, and a plurality of the first waveforms for calibration are measured. In step S412, the first electrical signals delivered from the waveform detector 12 are sequentially transferred as the discrimination object signal from waveform detector 12, the analog amplifier 13 expands the transient waveform of the discrimination object signal along the time-domain axis, and the AD converter 14 samples the amplified discrimination object signal and converts the discrimination object signal to digital data. In addition, in step S412, each of the rise characteristic-amount Uf and the fall characteristic-amount Df is calculated according to the flowchart illustrated in FIGS. 9 and 10.

Furthermore, in step S413, each of the coordinate points (rise characteristic-amount Uf, fall characteristic-amount Df) is calculated according to the flowchart illustrated in FIGS. 9 and 10, and a plurality of the coordinate points are plotted on the discrimination plane as illustrated in FIG. 11. After that, by the program counter 161, the process of the signal processing circuit 15 proceeds to step S414. In step S414, the linear equation determination circuit 152 of the signal processing circuit 15 calculates the average slope “a” of the discrimination linear equation U=aD+b from the distribution of the coordinate points plotted on the discrimination plane.

After that, by the program counter 161, the process of the signal processing circuit 15 proceeds to step S415. In step S415, the linear equation determination circuit 152 determines the intercept “b” of the discrimination linear equation. In step S416, the linear equation determination circuit 152 stores the values of the average slope “a” and the intercept “b” of the discrimination linear equation U=aD+b in the data storage device 18.

(Waveform Discrimination Program)

A series of the operations of waveform discrimination illustrated in FIGS. 9, 10, 15 and 16 can be executed by allowing a program executing algorithm equivalent to FIGS. 9, 10, 15 and 16 to control the waveform discrimination device illustrated in FIG. 1. The waveform discrimination program may be stored in the program storage device 19 illustrated in FIG. 1. In addition, the waveform discrimination program may be stored in a computer-readable recording medium, and by allowing the program storage device 19 to read the recording medium, a series of the operations of waveform discrimination according to the first embodiment may be executed.

Herein, the “computer-readable recording medium” may be any medium where various programs can be recorded, for example, an external memory device of a microprocessor, a semiconductor memory, a magnetic disk, an optical disk, a magneto-optical disk, a magnetic tape, or the like. More specifically, a flexible disk, a CD-ROM, an MO disk, a cassette tape, an open reel tape, and the like are included in the “computer-readable recording medium”.

Namely, the waveform discrimination program according to the first embodiment is a waveform discrimination program allowing the control circuit 17 illustrated in FIG. 1 to execute a series of instructions including:

(a) Instruction to the waveform detector 12 to execute receiving operation of a waveform of pulses-to-be-measured and so as to convert a physical quantity of the measured pulse to an electrical signal;

(b) Instruction to the analog amplifier 13 to execute amplifying operation of a transient waveform of the electrical signal by expanding the transient waveform of the electrical signal along a time-domain axis;

(c) Instruction to the AD converter 14 to execute sampling operation of the amplified electrical signal in rise and fall times of the electrical signal so as to convert the sampled electrical signal to digital data;

(d) Instruction to the difference value calculation circuit 153, an attenuation amount calculation circuit 154, and a difference value integration circuit 155 of a signal processing circuit 15 to execute cooperating operations with each other so as to calculate a characteristic-amount Uf of the rise time as a point on the first coordinate axis by using the digital data and to calculate a characteristic-amount Df of the fall time as a point on the second coordinate axis by using the digital data;

(e) Instruction to the two-dimensional coordinate plotting circuit 156 of the signal processing circuit 15 to execute defining operation of a set of the point on the first coordinate axis and the point on the second coordinate axis as a coordinate point and to plot the coordinate point on a discrimination plane defined by the first coordinate axis and the second coordinate axis; and

(f) Instruction to the waveform discrimination determination circuit 158 of the signal processing circuit 15 to execute discriminating operation from a plotted position of the coordinate point whether the measured pulse has a first waveform or the measured pulse has a second waveform different from the first waveform.

The control circuit 17 or the signal processing circuit 15 of the waveform discrimination device according to the first embodiment may be embodied by, for example, a flexible disk device (flexible disk drive) and an optical disk device (optical disk drive), which are embedded in the control circuit 17 or the signal processing circuit 15. Or alternatively, the flexible disk device and the optical disk device can be externally connected to the control circuit 17 or the signal processing circuit 15. By inserting a flexible disk into an insertion slot of the flexible disk drive or inserting a CD-ROM into an insertion slot of the optical disk drive and performing a predetermined read operation, the waveform discrimination program stored in such a recording medium can be installed into the program storage device 19, which implements the waveform discrimination device. In addition, through an information processing network such as the Internet, the waveform discrimination program can be stored in the program storage device 19.

### Other Embodiments

Heretofore, the invention is described by using the first embodiment. However, it should be noted that the description and drawings forming a portion of the disclosure are not be understood to limit the invention. It is obvious to the ordinarily skilled in the art that various alternative embodiments, examples, and operating techniques are available from the disclosure.

In the first embodiment described above, a case where the first waveform is an emitted-light waveform from the radiation-light converter 11 unique to the gamma ray, the second waveform is an emitted-light waveform from the radiation-light converter 11 unique to the neutron ray, and the waveform detector 12 is a photo detector, such that when the photo detector receives a light pulse having the first waveform, the photo detector transmits the first electrical signal, and when the photo detector receives another light pulse having the second waveform, the photo detector transmits the second electrical signal, is exemplarily described, but the invention is not limited to the description of the first embodiment. For example, the waveform detector 12 may be an acousto-electric converter, such that when the acousto-electric converter receives a sound wave having a first waveform, the acousto-electric converter transmits a first electrical signal, and when the acousto-electric converter another sound wave having a second waveform, the acousto-electric converter transmits a second electrical signal.

Like this, it should be noted that the invention includes various embodiments which are not disclosed herein. Therefore, the technical scope of the invention is defined only by the special technical feature prescribing claims, which is reasonably derived from the description heretofore.

### INDUSTRIAL APPLICABILITY

The invention is a waveform discrimination device, a waveform discrimination method, and a waveform discrimination program discriminating double pulse waveforms having different waveforms, and the invention can be applied to accurately separate gamma rays and neutrons generated from a radioactive material which is used for, for example, nuclear power generation or the like and does not exist in nature. In addition, the invention has an industrial applicability, for example, to clearly separate echoes caused by an extraneous material which cannot be found in measurement according to a propagation time in ultrasonic flaw detection by providing a unit of discriminating double echo pulse waveforms having different waveforms.

### EXPLANATIONS OF LETTERS OR NUMERALS

11 light conversion element
12 waveform detector
12a photo detector
13 analog amplifier
14 AD converter
15 signal processing circuit
16 display device
17 control circuit
18 data storage device
19 program storage device
21 housing
22 high-voltage power supply
23 circuit board
24 circuit board
31a, 31b, 32a, 32b, 32c cable
33 communication cable
151 window boundary condition determination circuit
152 linear equation determination circuit
153 difference value calculation circuit
154 attenuation amount calculation circuit
155 difference value integration circuit
156 two-dimensional coordinate plotting circuit
157 arithmetic-operation proceeding determination circuit
158 waveform discrimination determination circuit
159 waveform-points accumulation circuit
160 cumulative number display instruction circuit
161 program counter
162 data acquisition circuit
163 peak value determination circuit
164 data bus

1. A waveform discrimination device comprising:
a waveform detector configured to convert physical quantities of pulses to be measured to electrical signals, by receiving waveforms of the pulses;
an analog amplifier configured to amplify transient waveforms of the electrical signals by expanding the transient waveforms of the electrical signals along a time-domain axis;
an AD converter configured to sample the amplified electrical signals in rise and fall times of the electrical signals and convert the sampled electrical signals to digital data; and
a signal processing circuit configured to calculate a characteristic-amount of the rise time as a point on a first coordinate axis by calculating a difference value between the two consecutive digital data in the rise time, and calculate a characteristic-amount of the fall time as a point on a second coordinate axis, so as to define a set of the point on the first coordinate axis and the point on the second coordinate axis as a coordinate point, and plot the coordinate point on a discrimination plane defined by the first coordinate axis and the second coordinate axis,
wherein, by plotted positions of the coordinate point, whether the pulses has a first waveform or a second waveform different from the first waveform is discriminated.

2. The waveform discrimination device of claim 1, further comprising a radiation-light converter converting a neutron ray and a gamma ray to light, the neutron ray and the gamma ray having different characteristics of light emission,
wherein the waveform detector is a photo detector converting the light to the electrical signals.

3. The waveform discrimination device of claim 2, wherein the radiation-light converter is a scintillator made from any one of CsLiYCl, LiCaAlF₆, LiF/ZnS, LiBaF₃ and Li₆Gd(BO₃)₃.

4. The waveform discrimination device of claim 2, wherein the waveform detector is a photo detector converting light having a wavelength of 190 to 450 nm to the electrical signals.

5. The waveform discrimination device of claim 2, wherein the photo detector is any one of a photomultiplier tube, a semiconductor photodiode, a photodiode array, and a Geiger mode parallel readout APD pixel array.

6. The waveform discrimination device of claim 5,
wherein the photo detector is the photomultiplier tube, a signal output terminal and a reference potential terminal of the photomultiplier tube are connected between an input terminal of the analog amplifier and a ground terminal, and an input resistor of 5 kΩ or more is connected between the input terminal of the analog amplifier and the ground terminal.

7. The waveform discrimination device of claim 1, wherein the analog amplifier expands the transient waveform of the electrical signals along the time-domain axis so that a fall time of the electrical signals becomes two microseconds or more.

8. The waveform discrimination device of claim 7, wherein the signal processing circuit includes a waveform discrimination determination circuit inputting a physical quantity for calibration having a known waveform to the waveform detector in advance to determine whether or not the plotted position of the coordinate point exists within a discrimination window defined on the discrimination plane.

9. The waveform discrimination device of claim 8, wherein the waveform discrimination determination circuit defines a rectangular area surrounded by a lower limit identification value of the characteristic-amount of the fall time, an upper limit identification value of the characteristic-amount of the fall time, a lower limit identification value of the characteristic-amount of the rise time, and an upper limit identification value of the characteristic-amount of the rise time as the discrimination window.

10. The waveform discrimination device of claim 8,
wherein, in a case where it is determined that the plotted position of the coordinate point does not exist within the discrimination window, the waveform discrimination determination circuit discriminates that the pulses have the first waveform, and
wherein, in a case where it is determined that the plotted position of the coordinate point exists within the discrimination window, the waveform discrimination determination circuit determines whether or not the pulses exist in an area being closer to the second coordinate axis than to a straight line representing a discrimination linear equation.

11. The waveform discrimination device of claim 9, wherein the signal processing circuit further includes a difference value calculation circuit, the difference value is calculated by the difference value calculation circuit.

12. The waveform discrimination device of claim 11, wherein the signal processing circuit further includes a difference value integration circuit integrating the difference values to determine and calculate the characteristic-amount of the rise time.

13. The waveform discrimination device of claim 12, wherein the signal processing circuit further includes an attenuation amount calculation circuit calculating an attenuation amount in the fall time by using a difference between a peak value in the rise time and the digital data in the fall time.

14. The waveform discrimination device of claim 13, wherein the difference value calculation circuit calculates a difference value between two consecutive attenuation amounts in the fall time.

15. The waveform discrimination device of claim 14, wherein the difference value integration circuit integrates the difference values between the attenuation amounts to determine the characteristic-amount of the fall time.

16. A waveform discrimination method comprising:
receiving waveforms of pulses to be measured and converting a physical quantity of the pulses to electrical signals;
amplifying transient waveforms of the electrical signals by expanding the transient waveforms of the electrical signals along a time-domain axis;
sampling the amplified electrical signals in rise and fall times of the electrical signals and converting the sampled electrical signals to digital data;
calculating a characteristic-amount of the rise time as a point on the first coordinate axis by using the digital data, and calculating a characteristic-amount of the fall time as a point on the second coordinate axis;
defining a set of the point on the first coordinate axis and the point on the second coordinate axis as a coordinate point and plotting the coordinate point on a discrimination plane defined by the first coordinate axis and the second coordinate axis; and
discriminating from a plotted position of the coordinate point whether the pulses has a first waveform or a second waveform different from the first waveform,
wherein calculating the characteristic-amount of the rise time includes a step of calculating a difference value between the two consecutive digital data in the rise time.

17. The waveform discrimination method of claim 16, wherein, in the step of discriminating, by receiving a physical quantity for calibration having a known waveform to perform measurement in advance, it is determined whether or not the plotted position of the coordinate point exists within a discrimination window defined on the discrimination plane, so that the first waveform and the second waveform are discriminated.

18. The waveform discrimination method of claim 17, wherein the discrimination window is a rectangular area surrounded by a lower limit identification value of the characteristic-amount of the fall time, an upper limit identification value of the characteristic-amount of the fall time, a lower limit identification value of the characteristic-amount of the rise time, and an upper limit identification value of the characteristic-amount of the rise time.

19. The waveform discrimination method of claim 17,
wherein, in a case where it is determined that the plotted position of the coordinate point does not exist within the discrimination window, it is discriminated that the pulses have the first waveform, and
wherein, in a case where it is determined that the plotted position of the coordinate point exists within the discrimination window, it is determined whether or not the pulses exist in an area being closer to the second coordinate axis than to a straight line representing a discrimination linear equation.

20. (canceled)

21. The waveform discrimination method of claim 16, wherein calculating the characteristic-amount of the rise time further includes a step of integrating the difference values to determine the characteristic-amount of the rise time.

22. The waveform discrimination method of claim 21, wherein a peak value in the rise time is determined by comparing the two consecutive difference values.

23. The waveform discrimination method of claim 22, wherein calculating the characteristic-amount of the fall time includes a step of calculating an attenuation amount in the fall time by using a difference between the peak value in the rise time and the digital data in the fall time.

24. The waveform discrimination method of claim 23, wherein the step of calculating the characteristic-amount of the fall time includes a step of calculating a difference value between the two consecutive attenuation amounts in the fall time.

25. The waveform discrimination method of claim 24, wherein calculating the characteristic-amount of the fall time further includes a step of integrating the difference values between the attenuation amounts to determine the characteristic-amount of the fall time.

26. A waveform discrimination program allowing a control circuit to execute a series of instructions comprising:
instructions to a waveform detector to convert a physical quantity of pulses to be measured to electrical signals, by receiving a waveform of the pulses;
instructions to an analog amplifier to amplify transient waveforms of the electrical signals by expanding the transient waveforms of the electrical signals along a time-domain axis;
instructions to an AD converter to sample the amplified electrical signals in rise and fall times of the electrical signals and to convert the sampled electrical signals to digital data;
instructions to a difference value calculation circuit, an attenuation amount calculation circuit, and a difference value integration circuit of a signal processing circuit to cooperate with each other to calculate a characteristic-amount of the rise time as a point on the first coordinate axis by calculating a difference value between the two consecutive digital data in the rise time by the difference value calculation circuit and calculate a characteristic-amount of the fall time as a point on the second coordinate axis;
instructions to a two-dimensional coordinate plotting circuit of the signal processing circuit to define a set of the point on the first coordinate axis and the point on the second coordinate axis as a coordinate point and to plot the coordinate point on a discrimination plane defined by the first coordinate axis and the second coordinate axis; and
instructions to a waveform discrimination determination circuit of the signal processing circuit to discriminate from a plotted position of the coordinate point whether the pulse has a first waveform or a second waveform different from the first waveform.
